(19) United States
(12) Patent Application Publication
(10) Pub. No.: US 2011/0265974 A1
(43) Pub. Date: Nov. 3, 2011

(54) METHODS AND EQUIPMENT FOR HEATING AND COOLING BUILDING ZONES

(75) Inventor: Jeffrey H. Maxwell, Kelowna (CA)

(73) Assignee: TRAK INTERNATIONAL, LLC, St. Paul, MN (US)

(21) Appl. No.: 13/179,312

(22) Filed: Jul. 8, 2011

Related U.S. Application Data
(63) Continuation of application No. 12/607,679, filed on Oct. 28, 2009.
(60) Provisional application No. 61/108,961, filed on Oct. 28, 2008.

(51) Int. Cl. F25B 29/00; B23P 19/04

(52) U.S. Cl. 165/58; 29/428

(57) ABSTRACT

As discussed herein, a first aspect of the present invention provides a device for enabling an HVAC component to be easily connected to, and disconnected from, an HVAC system. The device can include a modular distribution box, hot and cold HVAC fluid inlet pipes, HVAC component supply and HVAC component return pipes, and hot and cold HVAC fluid outlet pipes, each of which can be coupled to the modular distribution box, and each of which can have a connector. The hot HVAC fluid inlet pipe's connector can be configured to connect to a hot HVAC pipe, and the cold HVAC fluid inlet pipe's connector can be configured to connect to a cold HVAC pipe. The HVAC component supply pipe's connector can be configured to connect to an inlet pipe of the HVAC component, and the HVAC component return pipe's connector can be configured to connect to an outlet pipe of the HVAC component. The hot HVAC fluid outlet pipe's connector can be configured to connect to the hot HVAC pipe, and the cold HVAC fluid outlet pipe's connector can be configured to connect to the cold HVAC pipe. The hot and cold HVAC fluid inlet pipes, the HVAC component supply and HVAC component return pipes, and the hot and cold HVAC fluid outlet pipes, permit the entire modular distribution box to be connected to and disconnected from the HVAC component and the HVAC system as a whole unit.

### CROSS-REFERENCE TO RELATED APPLICATION

This application is a continuation of U.S. application Ser. No. 12/607,679, filed Oct. 28, 2009, which claims priority under 35 U.S.C. §119(e) to U.S. provisional application 61/108,961, filed Oct. 28, 2008, the entirety of which is hereby incorporated by reference herein.

### BACKGROUND

HVAC systems involving water-to-water central heat pumps are becoming more common. In their most basic form, such systems include a heat pump that warms or cools HVAC fluid circulated through pipes within a building. A fan blows air from the conditioned space across warmed or cooled coils connected to the pipes. The temperature of the air blown from the fan across the coil (typically done by a fan coil unit) is thus affected by the temperature-controlled HVAC fluid flowing within the pipes. By controlling the temperature and flow rate of the HVAC fluid within the pipes, the location and configuration of the pipes and fan coil(s), the speed and capacity of the fan coil(s), and the parameters of various additional equipment that may be incorporated into the system, the conditioned space can be maintained at required conditions with relative ease.

Although heat pump HVAC systems are commonly more efficient than conventional HVAC systems, they still consume electrical energy to operate. Differently configured heat pump HVAC systems vary in energy consumption and efficiency. Most systems do not take advantage of various sources of “free” energy. Additionally, most early heat pump HVAC systems were slow to respond to building and space load changes and were more difficult for users to control than conventional HVAC systems. When they thus rely upon backup systems, such as electric duct heaters, they can have relatively high instantaneous electricity demand and overall higher electricity consumption. The distributed small compressors create noise and vibration problems and require continuous HVAC liquid flow rates to stay operational. The total system power consumption can become a significant related expense that devalues the energy and operation cost savings the technology can create.

### SUMMARY

In some embodiments, the present invention provides an energy efficient HVAC system that optionally includes a water-to-water heat pump, along with one or more components configured to take advantage of unused energy sources and/or energy sinks, thereby significantly reducing the amount of energy that is potentially required to be added to the system for efficient operation.

In some embodiments, the present invention provides a heat pump including two heat exchangers connected by two or more refrigeration circuits, with each circuit having an expansion valve and a compressor that are optionally in electronic communication with a main controller, thereby permitting relatively precise remote control of the heat pump.

In some embodiments, the present invention provides a group of multi-circuit water-to-water heat pumps connected together in parallel in a modular fashion, with each circuit of each heat pump having a remotely controllable expansion valve and/or compressor, thereby providing a highly flexible and responsive heat pump system.

In some embodiments, the present invention provides multiple individual heat pumps and/or groups of heat pumps connected in parallel (see previous paragraph) that are connected in series in order to achieve a relatively large temperature difference, with each heat pump or heat pump group being configured to operate within its optimal temperature range in incrementally achieving the relatively large temperature difference.

In some embodiments, the present invention provides a method of operating a multi-circuit heat pump, including (a) receiving instructions concerning what is needed of the heat pump from a main controller based on input from sensors located in various places in the HVAC system and (b) responding to those instructions by activating (or maintaining activation of) or deactivating (or maintaining deactivation of) one or more compressors in a selected sequence and at selected time intervals, provided that such response is not restricted based on the detection of heat pump or HVAC system irregularities.

In some embodiments, the present invention provides a method of monitoring for irregularities in heat pumps that are either activated or pending activation to prevent premature wear or failure of heat pump components and/or to improve energy efficiency in the heat pumps.

In some embodiments, the present invention provides an energy transfer component that includes an outer tube made of thermally conductive material and a concentric inner tube that can be made of thermally insulative material, with (a) HVAC fluid flowing turbulently through the channel between the inner and outer tubes, optionally guided by a spiraling barrier, such that heat transfer occurs between the turbulently flowing HVAC liquid and the surrounding earth, water, or combination thereof and (b) HVAC fluid flowing laminarly inside the inner tube, thereby minimizing heat transfer between the HVAC fluid flowing between the inner and outer tubes and the HVAC fluid flowing inside the inner tube.

In some embodiments, the present invention provides system components assembled as a modular box, which enables fast and easy installation and replacement of the modular box, thereby permitting assembly and repair of the distribution equipment in a more suitable setting, such as a machine shop.

In some embodiments, the present invention provides a distribution system that optionally accommodates potable water as the HVAC fluid by regularly circulating the potable water through a single coil in a fan box, that optionally includes a controller, that is in electronic communication with a main controller and/or one or more other components of the HVAC system.

Details of several aspects and embodiments of the present invention are provided herein.

Related technology is disclosed in commonly owned U.S. patent application Ser. Nos. 12/607,535 (filed on Oct. 28, 2009 and titled HIGH-EFFICIENCY HEAT PUMPS); 12/607,930 (filed on Oct. 28, 2009 and titled CONTROLS FOR HIGH EFFICIENCY HEAT PUMPS); 12/607,760 (filed on Oct. 28, 2009 and titled METHODS AND EQUIPMENT FOR GEOTHERMALLY EXCHANGING ENERGY). Each of the applications noted in this paragraph are hereby incorporated by reference herein in their entirety.

### BRIEF DESCRIPTION OF FIGURES

The following drawings are illustrative of particular embodiments of the present invention and therefore do not limit the scope of the invention. The drawings are not to scale (unless so stated) and are intended for use in conjunction with the explanations in the following detailed description. Embodiments of the present invention will hereinafter be described in conjunction with the appended drawings, wherein like numerals denote like elements.

FIG. 1A is a schematic diagram of a first illustrative HVAC system according to some embodiments of the present invention.

FIG. 1B is a schematic diagram of a second illustrative HVAC system according to some embodiments of the present invention.

FIG. 2 is a schematic diagram of an illustrative dual-circuit heat pump according to some embodiments of the present invention.

FIG. 3A is a flow diagram of an illustrative method for operation of a heat pump according to some embodiments of the present invention.

FIG. 3B is a flow diagram of an illustrative method for protecting against damage to the heat pump stemming from heat pump irregularities according to some embodiments of the present invention.

FIG. 4 is a flow diagram of an illustrative method for assembling a heat pump according to some embodiments of the present invention.

FIG. 5A is a schematic side view of an illustrative flow-through heat transfer component according to some embodiments of the present invention.

FIG. 5B is a schematic end view of the flow-through heat transfer component of FIG. 5A.

FIG. 6 is a schematic side view of an illustrative ground energy transfer component according to some embodiments of the present invention.

FIG. 7 is a schematic view of a distribution box with a control system module according to some embodiments of the present invention.

FIG. 8 is a schematic view of a portion of an HVAC system, including a single coil within a fan box, according to some embodiments of the present invention.

### DETAILED DESCRIPTION OF ILLUSTRATIVE EMBODIMENTS

The following detailed description is exemplary in nature and is not intended to limit the scope, applicability, or configuration of the invention in any way. Rather, the following description provides practical illustrations for implementing exemplary embodiments of the present invention. Examples of constructions, materials, dimensions, and manufacturing processes are provided for selected elements, and all other elements employ that which is known to those of skill in the field of the invention. Those skilled in the art will recognize that many of the examples provided have suitable alternatives that can be utilized.

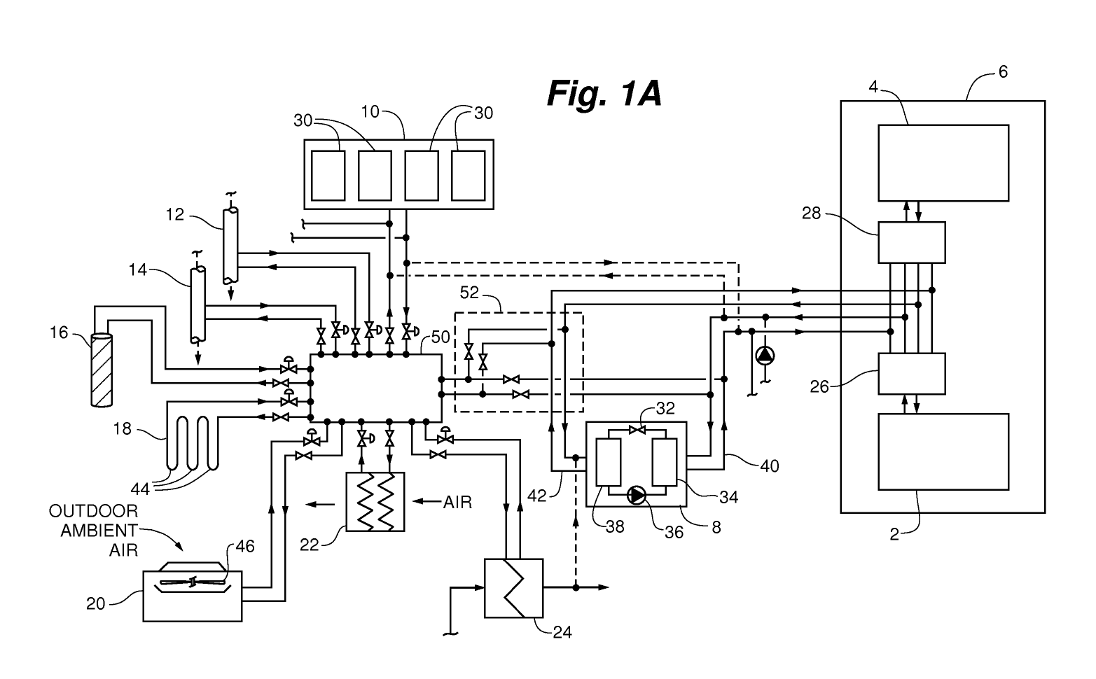

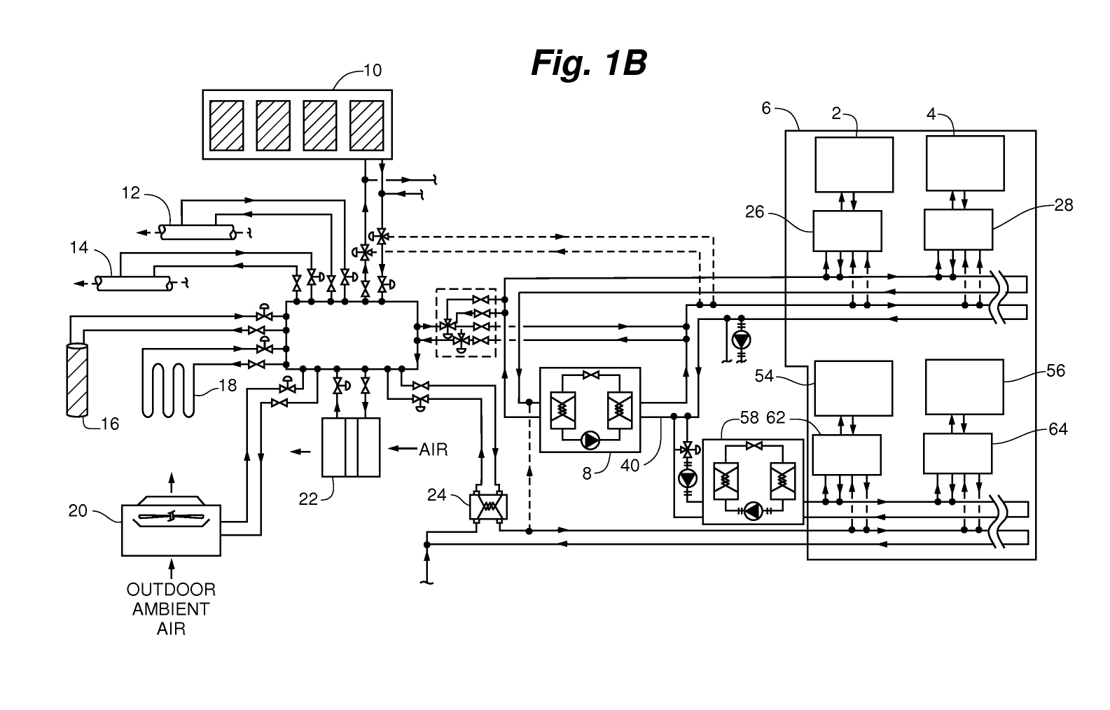

FIG. 1A shows an illustrative HVAC system for heating and/or cooling two zones 2, 4 within the conditioned space 6 of a building. The illustrative HVAC system includes a heat pump 8, several energy transfer components 10, 12, 14, 16, 18, 20, 22, 24, and distribution boxes 26, 28 (e.g., with control system modules). The illustrative HVAC system also includes a network of pipes and valves for distributing hot and/or cold HVAC fluid to the various components of the system. In many embodiments, the HVAC fluid can be water (e.g., treated water), an antifreeze solution (e.g., glycol mixed with water), or similar fluids. In some embodiments, the HVAC fluid can be domestic potable water. Individual components of the system are discussed in greater detail elsewhere herein.

It should be emphasized that the HVAC system of FIG. 1A is only illustrative. Some buildings include only one zone. Many buildings include more than one zone. Many embodiments of the present invention can be incorporated into large buildings with many zones and/or into groups of buildings with many zones having different embodiments complementing the energy balance. HVAC systems can include any suitable combination of energy transfer components, heat pumps, distribution components, and/or piping/valve distribution systems, based on a variety of design factors. As is discussed in greater detail elsewhere herein, an HVAC system can include suitable energy transfer component(s) with or without a heat pump, with or without distribution component(s), and with or without sections of the illustrated piping/valve distribution system. Similarly, an HVAC system can include one or more suitable heat pumps with or without energy transfer component(s), with or without distribution component(s), and with or without the illustrated piping/valve distribution system. Likewise, an HVAC system can include one or more distribution components with or without energy transfer component(s), with or without a heat pump, and with or without the illustrated piping/valve distribution system. As is discussed elsewhere herein, aspects of the illustrated piping/valve distribution system can be implemented into a variety of HVAC systems. Many embodiments include components other than those shown for taking advantage of sources of “free” energy. Many embodiments include components other than those shown for using transferred and free energy, such as snowmelt, radiant heating, domestic hot water, swimming pools, hot tubs, and so on.

The illustrative HVAC system of FIG. 1A includes a heat pump 8. Shown are four stages of the heat transfer cycle: a compressor 36, a condenser heat exchanger 34 rejecting energy, an expansion valve 32, and an evaporator heat exchanger 38 collecting energy. Heat pump refrigerant (e.g., R22, R134a, R407C, etc.) can cycle through the components of the heat pump 8 to reject and absorb heat from the sink and source HVAC fluids connected to the HVAC fluid side of the condenser and evaporator heat exchangers 34, 38. The heat pump refrigerant can circulate and migrate through the heat pump heat transfer cycle. The cycle can first be activated by starting a compressor 36. The work of the compressor 36 can compress any residual refrigerant liquid or returning vapor (gas) to a gas of higher pressure and temperature and thus motivate the refrigerant through the cycle. The high pressure and high temperature refrigerant can then enter the condenser heat exchanger 34, where the HVAC fluid can cause the refrigerant to condense from gas to liquid as it rejects sensible and latent heat energy to the comparatively cooler hot HVAC fluid. The refrigerant can then enter the expansion valve 32, where the passing refrigerant can be regulated to only an amount which will completely vaporize in the spatial volume of the evaporator heat exchanger 38. The suddenly reduced pressure and increased volume in the evaporator heat exchanger 38 can cause the liquid refrigerant to flash to gas and during its change of phase state to absorb its latent heat energy from the comparatively warmer cold HVAC fluid. The warmed low pressure refrigerant gas can then return to the compressor 36. Changes in the phase state of the heat pump refrigerant caused by pressure and volume changes, combined with temperature changes at the condenser heat exchanger 34 and the evaporator heat exchanger 38, can cause heat energy to be “pumped” from the connected cold HVAC fluid to the hot HVAC fluid.

This energy transfer can simultaneously (a) absorb heat energy into the heat pump refrigerant changing from liquid to gas at the evaporator heat exchanger 38, thereby chilling the HVAC fluid at the evaporator heat exchanger 38, and (b) reject heat from the heat pump refrigerant by temperature difference at the condenser heat exchanger 34, thereby heating the HVAC fluid at the condenser heat exchanger 34. In this way, cooling some HVAC fluid can be the free by-product of heating other HVAC fluid, and vice versa, from the same compressor work.

In heating the conditioned space 6, HVAC fluid can exit the heat pump 8 through heating loop 40 after passing through the condenser heat exchanger 34 and can then enter the conditioned space 6. In cooling the conditioned space 6, HVAC fluid can exit the heat pump 8 through cooling loop 42 after passing through the evaporator heat exchanger 38.

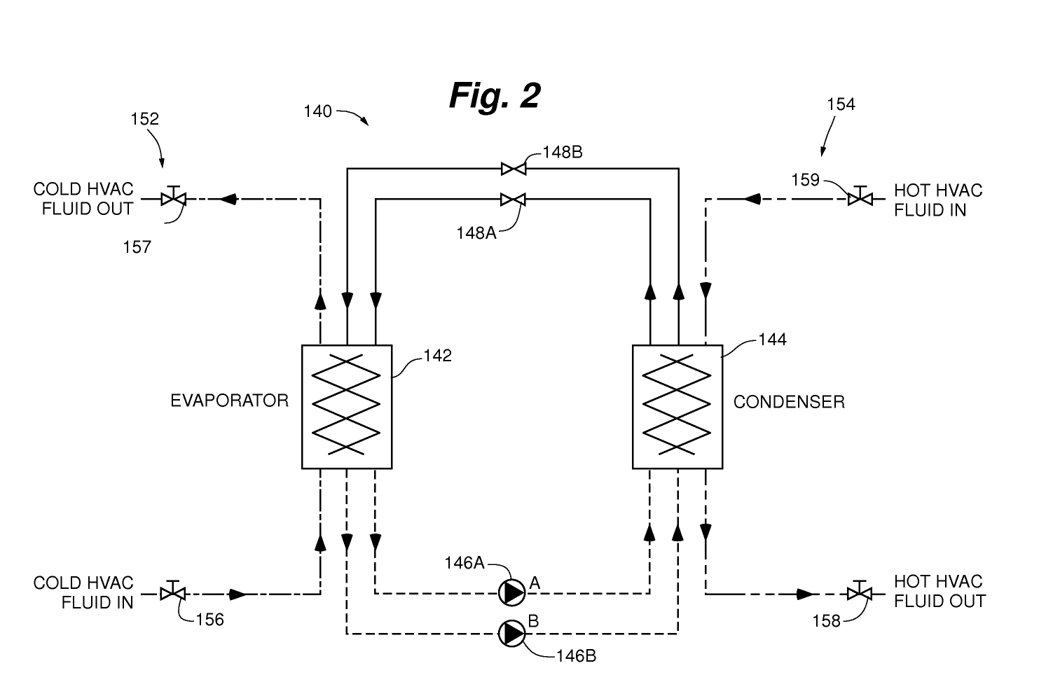

In some embodiments, components of the heat pump 8 can be selected and/or configured according to particular applications. In many embodiments, the heat pump 8 can have two or more refrigerant circuits. FIG. 2 shows an illustrative dual-circuit heat pump 140. The heat pump 140 includes an evaporator heat exchanger 142 and a condenser heat exchanger 144. The evaporator heat exchanger 142 can interact with a chilled HVAC fluid loop 152 and the condenser heat exchanger 144 can interact with a hot HVAC fluid loop 154. In this way, the dual-circuit heat pump 140 can provide a similar interface to HVAC systems as do conventional single-circuit heat pumps. In many embodiments, dual-circuit heat pumps can enable paired compressors within the heat pump frame to have separate isolated heat pump refrigerant circuits (avoiding equalization lines), providing staging and better control of the refrigerant circuit and conditioning of the HVAC fluid.

Inside the heat pump 140, two separate circuits (circuit A and circuit B in FIG. 2) can channel heat pump refrigerant through the condenser heat exchanger 144 and the evaporator heat exchanger 142. Circuit A can have a compressor 146A and an expansion valve 148A, and circuit B can have a compressor 146B and an expansion valve 148B. The heat pump refrigerant and its properties in Circuit A may be different than the heat pump refrigerant and its properties in Circuit B. At any given time, compressors 146A, 146B can both be operational, one of the compressors 146A or 146B can be operational, or neither compressor 146A nor 146B can be operational. In this way, the heat pump 140 can operate at 100% capacity, 50% capacity, or 0% capacity. In this way, the heat pump can be at peak efficiency when at 100% capacity and when at 50% capacity. In some embodiments, one or both of the compressors 146A and 146B can be modulated to provide for greater flexibility in operating capacity percentage. For example, one or both of the compressors 146A or 146B can be separately connected to a variable frequency drive; or one or the other of the compressors 146A, 146B can compress an alternate refrigerant of different properties, or one of the compressors 146A, 146B can experience its refrigerant in a different state as caused by a different tuning of the expansion valve 148A, 148B. Some heat pumps made and/or used according to the present invention provide significant enhancements in energy efficient heating and cooling.

In many embodiments, the evaporator heat exchanger 142 and/or the condenser heat exchanger 144 are plate-and-frame heat exchangers. Heat pump refrigerant and HVAC fluid can be channeled through alternating gaps between the plates. The plates can be made of thermally conductive material in order to facilitate heat transfer between the heat pump refrigerant and the HVAC fluid. Heat transfer can occur according to the design of the heat exchangers 142, 144 and the HVAC system when the heat pump refrigerant and the HVAC fluid are both flowing through the respective gaps between the plates. In many embodiments, such as that of FIG. 2, the heat pump refrigerant and the HVAC fluid flow through the heat exchangers 142, 144 in opposite directions.

For dual-circuit heat pumps, the heat pump refrigerant from one circuit can alternate with the heat pump refrigerant from the other circuit when flowing through the heat exchanger (evaporator 142 or condenser 144). In many embodiments, the heat exchangers can be of the brazed plate type, in which case the heat transfer fluids would flow through gaps between sealed plates. The respective fluids in the heat exchanger gaps would alternate between (a) heat pump refrigerant from circuit A, (b) HVAC fluid, (c) heat pump refrigerant from circuit B, (d) HVAC fluid, (e) heat pump refrigerant from circuit A, and so on. If both of the compressors 146A, 146B were operational, both gaps neighboring the HVAC fluid would have flowing heat pump refrigerant, meaning that the designed heat transfer could occur across each plate. If only one of the compressors 146A, 146B were operational, only one of the gaps neighboring the HVAC fluid would have flowing heat pump refrigerant, meaning that the designed heat transfer could occur across only half of the plates. If neither of the compressors 146A, 146B were operational, neither of the gaps neighboring the HVAC fluid would have flowing heat pump refrigerant, meaning that the designed heat transfer could not occur across any of the plates. By making operational both, either, or neither of the compressors 146A, 146B, the heat pump can operate at 100%, 50%, or 0% capacity.

In some embodiments, the absorption of heat from the HVAC fluid in the evaporator heat exchanger 142 in one or both of the heat pump circuits can be controlled via the expansion valves 148A, 148B. In many embodiments, the expansion valves 148A, 148B can be electronic expansion valves, which can control the superheat from the evaporator heat exchanger 142 across a broad range of valve percentages (e.g., from 0% to 100%). Many electronic expansion valves can react faster and more precisely to changing conditions in the evaporator heat exchanger 142 than a conventional expansion valve. Some electronic expansion valves can be configured to communicate electronically with an operator and/or a controller through a network (e.g., the Internet). In this way, the electronic expansion valves can be monitored and adjusted remotely. Often, the precise control of electronic expansion valves' superheat setting provides significant savings on operational costs. The high range of valve control and internal programming can enable continuous operation over a wider range of conditions from ice making to hot water heating on the same common refrigerant charge.

The performance of the dual-circuit heat pump 140 can be impacted by a variety of factors. As noted above, in some embodiments, the number of compressors 146A, 146B that are operational (along with, in some embodiments, modulation of one or both of the compressors 146A, 146B) can impact the performance of the heat pump 140. As also noted above, the pressure of the heat pump refrigerant in one or both of the circuits, as controlled via the expansion valves 148A, 148B, can impact the performance of the heat pump 140. In some embodiments, the selection of the heat pump refrigerant can impact the performance of the heat pump 140. Different heat pump refrigerants change states at different temperatures and pressures. The overall efficiency of the heat pump 140 can be affected by the characteristics of the refrigerant, including the energy absorbed or given off during a change of state. Thus, the selection of a heat pump refrigerant can have a significant impact on, e.g., the temperature difference across the heat pump 140 and the work input to motivate the temperature difference. In some embodiments, the volume of heat pump refrigerant added to either or both of the circuits can impact the performance of the heat pump 140. In some embodiments, the volume of oil in the heat pump refrigerant can impact performance of the heat pump 140. One or more of these and similar factors can be controlled to provide optimal heat pump performance, depending on the circumstances of the particular application. In some embodiments, the dual-circuit heat pump can reduce the number of mechanical connections and fittings for the HVAC fluids, thereby reducing flow restrictions while at the same time increasing performance.

In many embodiments, the heat pump 140 is designed and/or configured to produce repeatable temperature differences across the respective heat exchangers 142, 144. In some instances, flow properties of the HVAC fluid in the chilled HVAC fluid loop 152 and/or the hot HVAC fluid loop 154 can be adjusted with control valves 156, 157, 158, 159 to achieve temperature differences across the heat exchangers 142, 144 that differ from those that would have been achieved in absence of the adjustment with the control valves 156, 157, 158, 159. In some embodiments, a percentage of the HVAC fluid can bypass a heat exchanger by means of one or more bypass valves.

In some embodiments, multiple heat pumps 140 are made in modular fashion, such that each heat pump 140 is a self-contained unit with clearly defined interfaces to other HVAC system components, including other heat pumps. Such a setup can provide a significant degree of flexibility in operating capacity percentage. The number of heat pumps (and specifically the number of compressors) is directly related to the number of operating capacity levels. The number of operating capacity levels is equal to the number of compressors plus one (accounting for 0% operating capacity). For example, with five dual-circuit heat pumps connected in parallel, there are eleven operating capacity levels. Assuming that all five heat pumps have similar configurations, the heat pumps collectively can operate at 0% (none of the compressors operational), 10% (one of the ten compressors operational), 20% (two of the ten compressors operational), and so on. The HVAC fluid flow can have equivalent capacity levels of reduced pumping energy with each refrigerant circuit still operating at optimum capacity and efficiency. In this way, the heat pumps collectively can provide what the HVAC system demands in a more precisely tailored fashion, thereby significantly improving energy efficiency.

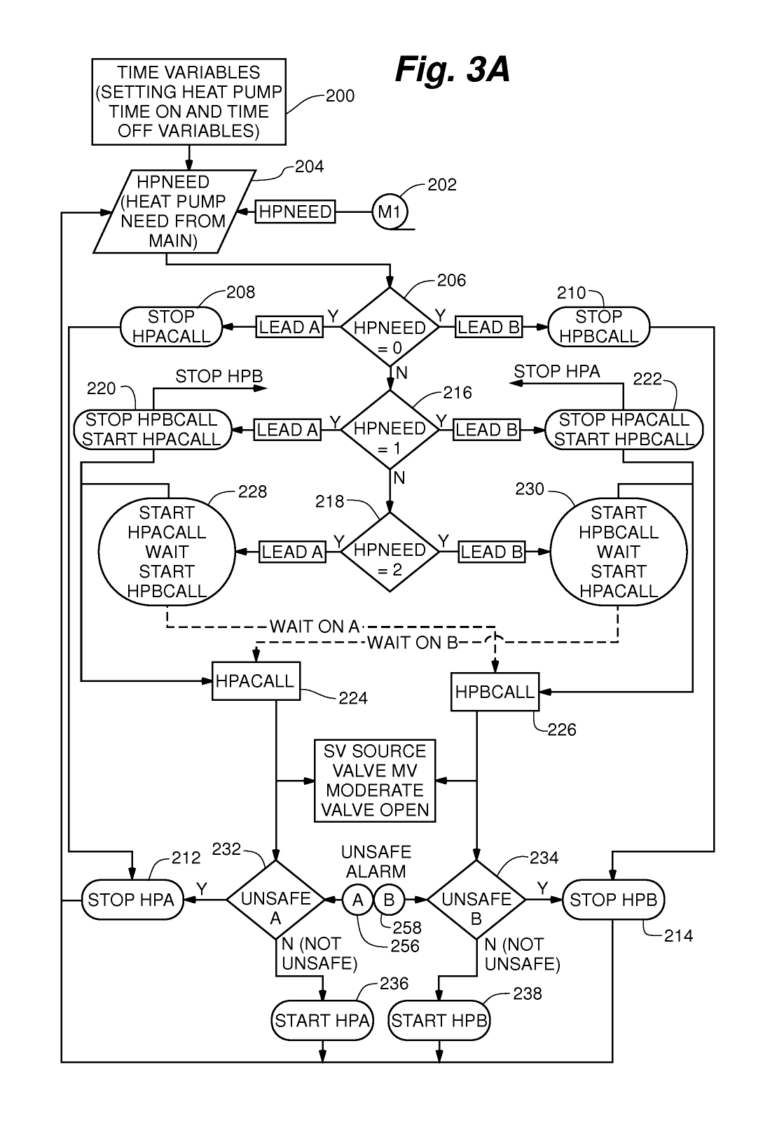

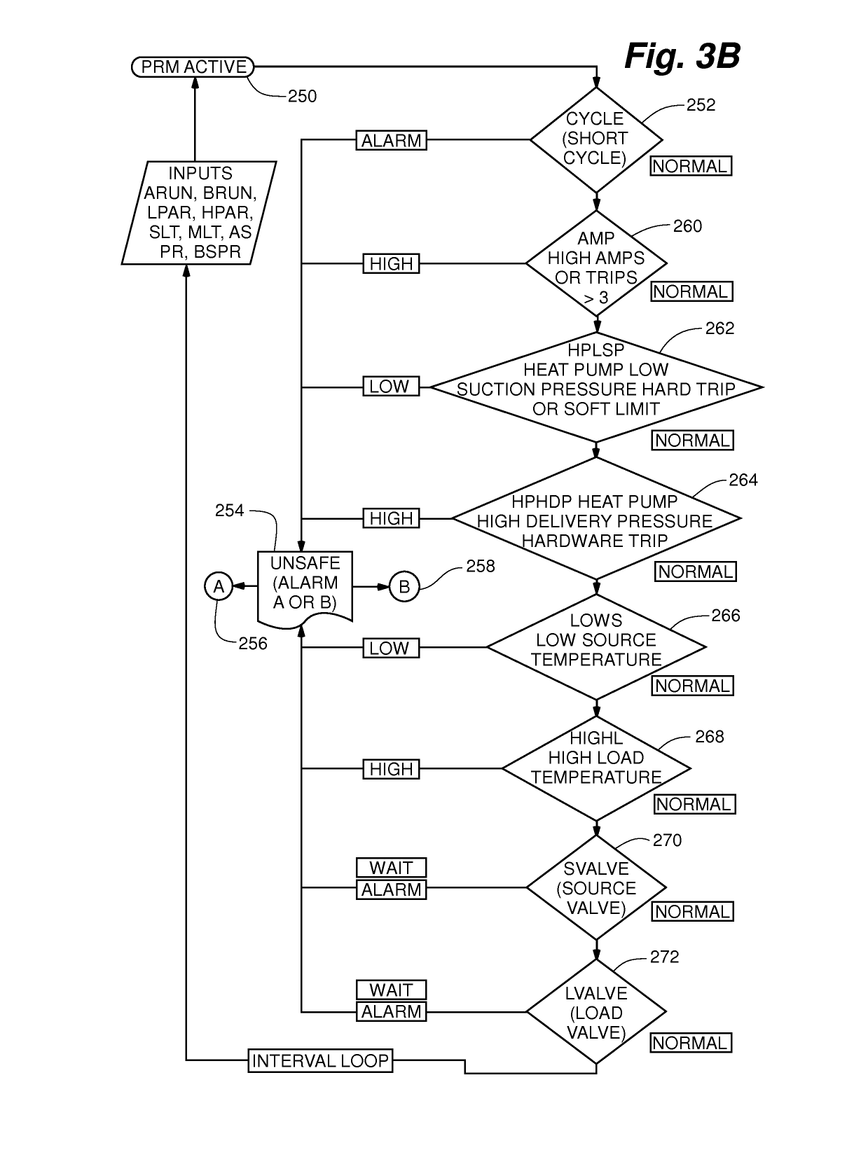

Heat pumps according to the present invention can be controlled in a variety of ways. FIGS. 3A-3B show illustrative methods for controlling dual-circuit heat pumps (such as the heat pump of FIG. 2). FIG. 3A shows an illustrative method for operation of the heat pump, based on instructions provided regarding what is needed from the heat pump. FIG. 3B shows an illustrative method for monitoring for heat pump irregularities and triggering the heat pump to turn off in the event that one or more of such irregularities is detected.

Referring to FIG. 3A, the time variables (e.g., the heat pump time on and time off variables) of the heat pump can be set (200). The automatic controls can measure and record the time duration a particular heat pump has been on or the time duration a particular heat pump has been off. Outputs from the main controller 202 of the HVAC system can send a signal to the heat pump controller indicating what is needed of the heat pump (204). Sensors positioned throughout the HVAC system can provide input to the main controller 202 concerning the conditions of the HVAC fluid. For example, referring to FIG. 1A, the main controller of the HVAC system can receive input from a temperature sensor reading the temperature of the returning hot HVAC fluid. The main controller can compare the desired conditions with the actual conditions and determine what role the heat pump can play in bringing the actual conditions into conformity with the desired conditions. The main controller can generate instructions concerning the role of the heat pump and can provide those instructions to the heat pump controller, as indicated by step (204) of FIG. 3A.

Referring again to FIG. 3A, the instructions provided by the main controller 202 to the heat pump controller (204) can relate to one or more of several variables of the heat pump. The operation of a heat pump controller can be overridden and supervised automatically by the main controller 202 or manually (e.g., by the building operator) at the heat pump, at a local computer monitoring the HVAC system, or through a network, such as the internet. For example, the instructions can manually deactivate a heat pump for servicing. The operations of an expansion valve controller can be overridden and supervised automatically by the main controller 202 or manually (e.g., by the building operator) at the heat pump, at a local computer monitoring the HVAC system, or through a network, such as the internet. For example, the instructions can change the superheat setpoint.

In many embodiments, the instructions call for the activation or deactivation of one or both of the heat pump's compressors. The heat pump controller can determine whether the instructions call for deactivation of both compressors (deactivate if activated or remain deactivated if already deactivated) (206). If the heat pump controller determines that the instructions indeed call for deactivation of both compressors, the heat pump controller can signal both compressors accordingly (208, 210), which can result in both compressors being stopped (212, 214). If the heat pump determines that the instructions call for activation of at least one compressor (activate if deactivated or remain activated if already activated), the heat pump can move to the next level of analysis.

If the heat pump controller determines that the instructions call for activation of at least one of the compressors, the heat pump controller can determine whether the instructions call for activation of only one of the compressors (216) or activation of both of the compressors (218). If the heat pump controller determines that the instructions call for activation of only one of the compressors, the heat pump controller can signal activation of either compressor A (220) or compressor B (222). This can result in a call of compressor A (224) or compressor B (226), pending inspection for irregularities (described in greater detail below). Whichever compressor is not called is/remains deactivated (212, 214).

When instructions call for activation of only one compressor, the heat pump controller can call either compressor A or compressor B based on an alternating or priority wear schedule. If either compressor A or compressor B were always called in this situation, that compressor would wear significantly faster than the other. Accordingly, a schedule can be established to encourage even wear of the two compressors or the preservation of one of the components. The digital control of the embodiment can enable many scheduling variations. In some embodiments, the heat pump controller determines which of the compressors to call. In some embodiments, the main controller determines which of the two controllers to call.

When the heat pump controller determines that the heat pump controller calls for activation of both compressors, the heat pump controller can signal activation of the compressors in a staggered fashion. In some instances, the heat pump controller can signal activation of compressor A first, followed by activation of compressor B after a time delay (228). This can result in (a) a call of compressor A (224), pending inspection for irregularities, (b) a period of delay as determined by reduced Amperage of the first stage and verification after the delay of a continued need, and (c) a call of compressor B (226), pending inspection for irregularities. In some instances, the heat pump controller can signal activation of compressor B first, followed by activation of compressor A after a delay (230). This can result in (a) a call of compressor B (226), pending inspection for irregularities, (b) a period of delay and confirmations, and (c) a call of compressor A (224), pending inspection for irregularities. Which compressor to activate first is often determined according to a schedule designed to reduce the likelihood of uneven wear between the compressors or overall long-term reliability of the system. The heat pump controller and/or the main controller can make this determination in a manner similar to the determination of which compressor to call when only one compressor is requested.

In some embodiments, the call for activation of a compressor can open the source valve SV for the cold HVAC fluid to the evaporator heat exchanger and open the load (moderate) valve MV for the hot HVAC fluid to the condenser heat exchanger. In many embodiments, the valves will close when both compressors are off. Operating the valves in this manner can reduce the pumping costs of the system, enable modules to operate at lower system flows, and prevent refrigerant migrations within the heat pump system from occurring when the heat pump is not active.

As alluded to above, before activating one or both of the compressors, the heat pump can be inspected for one or more irregularities (232, 234). Such an inspection can also be called a safety inspection in reference to making sure that activation of the compressor(s) will not damage the heat pump. If the heat pump controller determines that activation of either of the compressors (232, 234) would be unsafe, the heat pump controller can disable the activation of the compressor(s) (212, 214). If the heat pump controller determines that activation of one or both compressors would not be unsafe (232, 234), the heat pump controller can proceed with activation of the compressor(s) (236, 238).

FIG. 3B shows an illustrative method of monitoring for heat pump irregularities and/or heat pump safety concerns. As can be seen, the method of FIG. 3B includes eight tests. Other methods according to the present invention may include a greater or lesser number of tests. Other methods according to the present invention may involve one or more of the tests illustrated in FIG. 3B in a different order. A variety of tests, combinations, and orders are possible.

The heat pump controller can first activate the method (250). When a compressor is called, but before the compressor is turned on, the method can be activated. If the method detects no irregularities, the compressor can be turned on. In many embodiments, while the compressor is turned on, the method can run on a continuous basis. In such embodiments, if the method detects an irregularity or safety concern while the compressor is operating, the heat pump controller can cause the compressor to be deactivated. In most embodiments, the method of FIG. 3B can be performed in a relatively short period of time (e.g., once per second) to accommodate active compressors.

In many embodiments, the method of FIG. 3B supplements, or is supplemented by, protections that are hard-wired into the heat pump components themselves. The hard-wired protections can monitor for some or all of the irregularities that are monitored for by the heat pump controller. In many such embodiments, the heat pump controller safety tests are more conservative than those of the hard-wired heat pump components. In many such embodiments, the heat pump controller safety tests and the hard-wired safety tests can serve as back ups to one another in the event that one of the safety tests does not properly detect a potentially damaging heat pump irregularity.

With the method in active mode, the heat pump controller can run a variety of safety tests. One test can prevent compressors from being subjected to repeated short cycles (252). A compressor subjected to repeated short cycles can wear prematurely or be damaged. Embodiments of the present invention can prevent short cycles, thereby reducing the likelihood of premature wear of the compressor or heat pump failure. The heat pump controller can determine whether a compressor was just recently deactivated (e.g., within the past 10 or 15 minutes). In such a situation, the heat pump controller typically delays activation of the compressor to give it an appropriate amount of recovery (e.g., 10-15 minutes). Given the large size of most HVAC systems and given the fact that gradual changes in space conditions are typically desirable, the delay in activation of one compressor does not typically impede performance of the HVAC system.

If the heat pump controller determines that the compressor was recently deactivated, the heat pump controller can generate an alarm signal, signifying a condition in which operation of the compressor would be unsafe to the compressor (254). If the test identifies a potentially unsafe short cycle in compressor A, the unsafe condition is associated with compressor A (256). If the test identifies a potentially unsafe short cycle in compressor B, the unsafe condition is associated with compressor B (258). Referring to FIG. 3A, unsafe conditions associated with the respective compressors are shown (256, 258). As alluded to above, if either of these inputs (256, 258) indicate an unsafe condition, activation of the corresponding compressor will be prevented.

Referring again to FIG. 3B, if the heat pump controller determines that activating the called for compressor would not result in a potentially unsafe short cycle, the heat pump can administer additional safety tests. Another test monitors for irregular or inappropriate current draw experienced by the relevant compressor (260). Inappropriate current draw can result from, e.g., a change in load, a faulty power supply, and other reasons. If the heat pump controller detects an irregular or inappropriate current draw, the heat pump controller can generate a “high” signal, signifying a condition in which operation of the compressor would be unsafe to the compressor (254). As is discussed elsewhere herein, this condition can be associated with a compressor, which can prevent activation of, or deactivate, that compressor.

The third test of the illustrative method of FIG. 3B monitors for abnormally low suction pressure (262). This test can activate an alarm if the evaporator inlet refrigerant pressure is below a determined safe level that would cause “slugging” or fluidized refrigerant in damaging amounts to enter the compressor. If allowed to enter the compressor, mechanisms can be bent or broken. If the heat pump controller detects an abnormally low suction pressure, the heat pump controller can generate a “low” signal, signifying a condition in which operation of the compressor would be unsafe to the compressor (254). As is discussed elsewhere herein, this condition can be associated with a compressor, which can prevent activation of, or deactivate, that compressor.

The fourth test of the illustrative method of FIG. 3B monitors for abnormally high delivery pressure (264). This test can activate an alarm if the condenser outlet refrigerant pressure is above a determined safe level that would cause overheating and burning of the compressor windings. If allowed to over-pressurize, the compressor can be irreparably damaged. If the heat pump controller detects abnormally high delivery pressure, the heat pump controller can generate a “high” signal, signifying a condition in which operation of the compressor would be unsafe to the compressor (254). As is discussed elsewhere herein, this condition can be associated with a compressor, which can prevent activation of, or deactivate, that compressor.

The fifth test of the illustrative method of FIG. 3B monitors for abnormally low source temperature (266). This test can activate an alarm if the leaving HVAC fluid temperature is below a predetermined minimum that can cause the HVAC fluid in the evaporator to freeze or “gel” creating a “freeze rupture” in the heat pump condenser. This event can lead to a splitting of the plates in the condenser heat exchanger and leakage, a blockage of the HVAC fluid flow, and low suction pressure of the refrigerant flow. If the heat pump controller detects abnormally low source temperature, the heat pump controller can generate a “low” signal, signifying a condition in which operation of the compressor would be unsafe to the compressor (254). As is discussed elsewhere herein, this condition can be associated with a compressor, which can prevent activation of, or deactivate, that compressor.

The sixth test of the illustrative method of FIG. 3B monitors for abnormally high load temperature (268). This test can be activated if the hot HVAC fluid leaving the heat pump condenser is above a predetermined set point. If the leaving hot HVAC fluid is too hot, it can lead to unsafe fluid temperatures in the HVAC system with the potential for burning skin, damaging piping, activating secondary alarms, and other events. In the event of high load temperature, the compressor is deactivated until a predetermined reset level is achieved. If the heat pump controller detects abnormally high load temperature, the heat pump controller can generate a “high” signal, signifying a condition in which operation of the compressor would be unsafe to the compressor (254). As is discussed elsewhere herein, this condition can be associated with a compressor, which can prevent activation of, or deactivate, that compressor.

The seventh test of the illustrative method of FIG. 3B monitors for an abnormal positioning of the source valve (270). This test can activate an alarm if the heat pump compressors are called to turn on and the source valve is not in a position to allow flow of the HVAC fluid through the heat pump evaporator. If undetected, this event could cause secondary alarms (noted elsewhere herein) that would be caused by low suction and subsequent freeze rupturing. If the heat pump controller detects an abnormal positioning of the source valve, the heat pump controller can generate an “alarm” signal, signifying a condition in which operation of the compressor would be unsafe to the compressor (254). As is discussed elsewhere herein, this condition can be associated with a compressor, which can prevent activation of, or deactivate, that compressor.

The eighth test of the illustrative method of FIG. 3B monitors for an abnormal positioning of the load valve (272). This test can activate an alarm if the heat pump compressors are called to turn on and the load valve is not in a position to allow flow of the HVAC fluid through the heat pump condenser. If undetected, this event could cause secondary alarms as noted herein that would be caused by high discharge pressure and subsequent compressor overheating. If the heat pump controller detects an abnormal positioning of the load valve, the heat pump controller can generate an “alarm” signal, signifying a condition in which operation of the compressor would be unsafe to the compressor (254). As is discussed elsewhere herein, this condition can be associated with a compressor, which can prevent activation of, or deactivate, that compressor.

Monitoring for heat pump irregularities, e.g., by the illustrative method shown in FIG. 3B, can provide a variety of advantages. Some methods can assure health and safety measures related to the temperature of the HVAC fluid. Some methods can attract attention to other failures in the overall HVAC system. Some methods can help in the long-term control of the HVAC system. Some methods can prevent permanent damage and premature wear of the compressors or other components of the heat pump and secondary components in the HVAC system. Some methods can maintain and provide increased energy efficiency of the heat pump and the HVAC system.

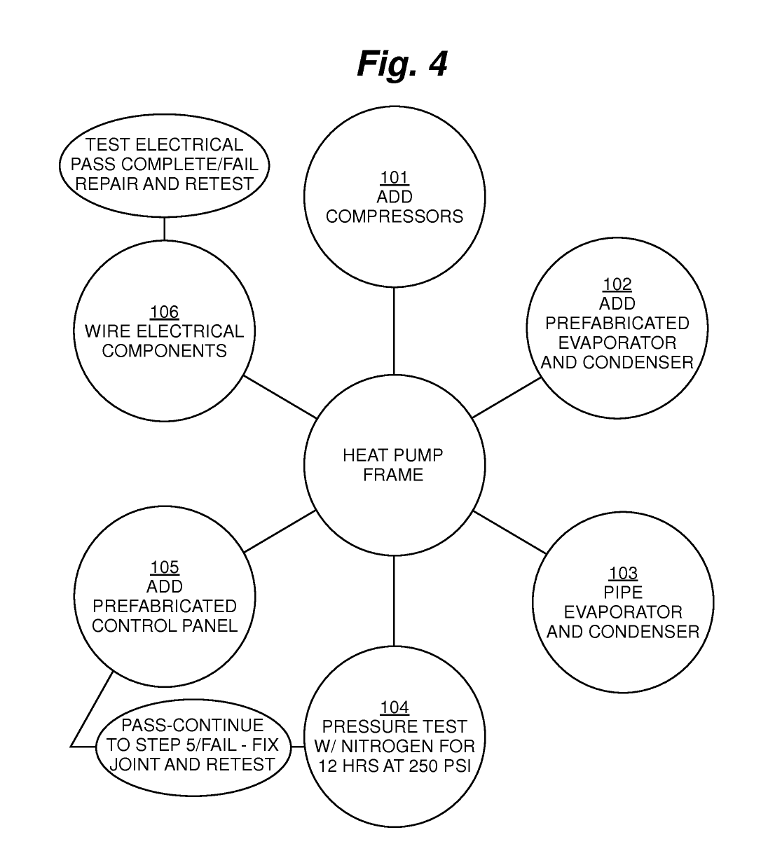

Many heat pump embodiments described herein can be assembled according to a variety of methods. FIG. 4 provides an illustrative heat pump assembly method. First, a heat pump frame can be selected. The heat pump frame can be selected based on the size of the heat pump and a variety of other factors. In some instances, heat pumps can be combined to provide a 30-ton capacity, a 60-ton capacity, or other desired capacity.

Compressors can be added to the heat pump frame (101). In many embodiments, the compressor is a scroll compressor. The compressor can be smooth in operation, compact, with good motor protection. The compact size of such embodiments can permit the compressor to be built into relatively small heat pump frames and modules that can be introduced to retrofit spaces through normal doorways. In some embodiments, the compressor includes relatively few moving parts with better reliability. In some embodiments, the compressor is quieter and more energy efficient than other compressors. An example of a compressor that is suitable for some embodiments of the present invention is the Copeland Scroll ZR380. One advantage of using many such compressors according to embodiments of the present invention is the relatively quiet operation. Quiet operation of the compressor can enable a tolerable noise level in a mechanical room, even with open construction of some embodiments. This allows an operator to readily see piping (e.g. to observe frosting, etc.) without the removal of covers or other sound attenuation panels. One advantage of using many such compressors according to embodiments of the present invention is staging of capacity to achieve ideal compressor loading. Staging of compressors on individual refrigeration circuits enhances reliability and performance of the HVAC system.

Condenser and evaporator heat exchangers can be added to the heat pump frame (102). The evaporator and condenser heat exchangers can be piped with the relevant compressors (103) in common or separate refrigerant circuits for the common hot and cold HVAC fluids. In some embodiments, components of the dryer shell can be silver soldered or Sil-Fos welded to minimize leaks. In some embodiments, the core of the dryer can be removed and replaced simply (e.g., without welding).

A pressure test can be conducted on the heat pump (104). The pressure test can comprise adding nitrogen to the heat pump for a period of 12 hours at a pressure of 250 psi. If the heat pump passes the pressure test, it can be ready for the next step in the assembly process. If the heat pump fails, the failing joint can be fixed and the pressure test can be repeated until it passes (104).

A control panel can be added to the heat pump frame (105). The control panel can be prefabricated. In some embodiments, the compressor mounting can be accessed through a hinged electrical panel, thereby maintaining maintenance access if the heat pump modules are connected side by side.

The various electrical components of the heat pump can be wired (106). The heat pump can then be subjected to an electrical test and safety certification. If the heat pump passes the electrical test and safety certification, the heat pump assembly process can be complete. If the heat pump fails the electrical test, the faulty wiring can be repaired, and the heat pump wiring and electrical components can be retested until the heat pump passes the electrical test and achieves safety certification (106).

Referring again to FIG. 1A, as mentioned above, the HVAC system of FIG. 1A includes a network of pipes and valves for distributing HVAC fluid to various components. The energy transfer components of FIG. 1A, which are discussed in greater detail elsewhere herein, are connected to one another via a main loop 50. HVAC fluid can pass through the main loop 50 and, depending on the circumstances, can also pass through one or more of the energy transfer components. For example, in some heating operations, HVAC fluid can enter the main loop 50, pass through the solar thermal panel 10 and/or the laundry heat transfer component 12 and/or the waste water heat transfer component 14 and/or the ground energy transfer component 16 and/or the geothermal well system 18 and/or the outdoor air energy transfer component 20 and/or the exhaust heat transfer component 22 and/or the domestic cold water heat exchanger 24. As the HVAC fluid passes through the one or more energy transfer components during a heating operation, the HVAC fluid can pick up heat from the energy transfer components, thereby raising the temperature of the HVAC fluid. Depending on the circumstances, the HVAC fluid may bypass one or more of the energy transfer components (e.g., by closing the valves to the energy transfer component(s)) as it passes through the main loop 50. In some embodiments, the HVAC fluid from one or more energy transfer components can be tied directly into the HVAC loops 40, 42 feeding the conditioned space 6. This is shown in FIG. 1A for the solar thermal panel 10, though it could be done for any individual energy transfer component or combination of energy transfer components.

In heating operations, HVAC fluid can pass through the energy transfer component(s) on its way to the conditioned space 6 or on its way from the conditioned space 6. In some embodiments, HVAC fluid travels from the output of the heat pump's condenser heat exchanger 34 into the conditioned space 6, as well as into and through the main loop 50 (or to one or more individual energy transfer components), as well as back to the input of the heat pump's condenser heat exchanger 34. In this way, the energy transfer component(s) can provide HVAC fluid to the heat pump that is warmer than it otherwise would be. In many such embodiments, the energy transfer components can provide a larger change in temperature. In some embodiments, HVAC fluid travels from the output of the heat pump's condenser heat exchanger 34 through the main loop 50 (or to one or more individual energy transfer components) to the conditioned space 6 back to the input of the heat pump's condenser heat exchanger 34. In this way, the energy transfer component(s) can further warm HVAC fluid received from the heat pump 8. In some embodiments, HVAC fluid can pass through one or more energy transfer components between exiting the conditioned space 6 and entering the heat pump 8 and also pass through one or more energy transfer components between exiting the heat pump 8 and entering the conditioned space 6. The control system of the heat pump 8 can be regulated to account for the presence of one or more energy transfer components.

The HVAC system of FIG. 1A includes a cooling loop 42 that can be used in cooling operations. As shown in configuration 52, valves can be used to channel HVAC fluid between the heat pump's condenser heat exchanger 34 and the main loop 50 and/or between the heat pump's evaporator heat exchanger 38 and the main loop 50. In some embodiments, the valving configuration 52 may occur individually for each energy transfer component. For example, HVAC fluid can enter the cooling loop 42 (and be directed to the main loop 50 by the system valving 52), pass through the ground energy transfer component 16 and/or the geothermal well system 18 and/or the outdoor air energy transfer component 20 and/or the exhaust heat transfer component 22. In another example, HVAC fluid can enter the cooling loop 42 (and be directed to the main loop 50 by the system valving 52), pass through the solar thermal panel 10 and/or the laundry heat transfer component 12 and/or the waste water heat transfer component 14 and/or the domestic cold water heat exchanger 24. In another example, HVAC fluid can enter the cooling loop 42 (and be directed to the main loop 50 by the system valving 52) and pass through one energy transfer component while at the same time the HVAC fluid can enter the heating loop 40 (and be directed to a second loop by a valving configuration) and pass through an energy rejection sink. Many variations are possible. Again, depending on the circumstances, the HVAC fluid may bypass one or more of the energy transfer components (e.g., by closing the valves 52 to the energy transfer component(s)) as it passes through the cooling loop 42 and the main loop 50.

As with heating operations, in cooling operations, HVAC fluid can pass through the energy transfer component(s) which can reject heat away from the conditioned space 6. In some embodiments, HVAC fluid travels from the output of the heat pump's evaporator heat exchanger 38 to the conditioned space 6 through cooling loop 42 and (by way of the valving configuration 52) the main loop 50 (or to one or more individual energy transfer components) back to the input of the heat pump's evaporator heat exchanger 38. Energy transfer components that absorb energy from the HVAC fluid when their environments are warmer than the HVAC fluid become energy rejection components. In this way, the energy transfer component(s) can provide HVAC fluid to the heat pump that is cooler than it otherwise would be. In some embodiments, HVAC fluid travels from the output of the heat pump's evaporator heat exchanger 38 through the cooling loop 42 and the main loop 50 (or to one or more individual energy transfer components) to the conditioned space 6 back to the input of the heat pump's evaporator heat exchanger 38. In this way, the energy transfer component(s) can further cool HVAC fluid received from the heat pump 8. In some embodiments, HVAC fluid can pass through one or more energy transfer components between exiting the conditioned space 6 and entering the heat pump 8 and also pass through one or more energy transfer components between exiting the heat pump 8 and entering the conditioned space 6. As noted above, the control system of the heat pump 8 can be adjusted to account for the presence of one or more energy transfer components. Thus, in many embodiments, HVAC fluid can recover energy from, and/or reject energy to, one or more energy transfer components. HVAC systems can include various individual valve configurations enabling some of the energy transfer components to serve as energy recovery components and others to serve as energy rejection components. Many functional permutations and combinations are possible.

As discussed elsewhere herein, many embodiments can perform heating operations and cooling operations simultaneously. One or more compressors can be activated, causing heat pump refrigerant to cycle through the heat pump components. The heat pump refrigerant can chill HVAC fluid at the evaporator heat exchanger 38 and simultaneously heat HVAC fluid at the condenser heat exchanger 34. In this way, heating and cooling different HVAC fluids can involve no more compressor work than heating or cooling alone. HVAC systems can include a variety of components, which can be configured and operated in a variety of ways. Thus, embodiments of the present invention can reliably and efficiently serve a wide variety of applications.

FIG. 1B shows an illustrative HVAC system similar to that of FIG. 1A. As can be seen, like the HVAC system of FIG. 1A, the HVAC system of FIG. 1B includes a heat pump 8, a main loop 50 with connections to various energy transfer components 10, 12, 14, 16, 18, 20, 22, 24, and a cooling loop 42 for heating and cooling zones 2, 4 of conditioned space 6. The HVAC system of FIG. 1B can also provide heating for zones 54 and 56 of conditioned space 6. Some or all of the HVAC fluid exiting the heat pump 8 can be routed through a second heat pump 58 to further increase the temperature of a second and separated HVAC fluid (often domestic hot water) before it enters zones 54, 56 of conditioned space 6. Often, the kinds of zones that would benefit from passing through multiple heat pumps are zones that require HVAC fluid at significantly higher temperatures (e.g., higher temperature domestic hot water, process water for laundry use, process water for municipal or industrial applications). When the HVAC fluid has passed through the second heat pump 58, the HVAC fluid can pass to zones 54, 56 through respective distribution boxes 62, 64.

HVAC systems according to embodiments of the present invention can arrange two or three or any suitable number of heat pumps (and/or groups of heat pumps arranged in parallel) in a series relationship to progressively increase the temperature of HVAC fluid passing through them. For example, a first heat pump can increase the temperature of HVAC fluid from 15 degrees Fahrenheit to 60 degrees Fahrenheit. A second heat pump can take that 60-degree HVAC fluid and increase its temperature to 120 degrees Fahrenheit. A third heat pump can take that 120-degree HVAC fluid and increase its temperature to 160 degrees Fahrenheit. This sequence can continue until the temperature of the HVAC fluid reaches a desired (e.g., selected, predetermined) level. In this example, three heat pumps increase the temperature of HVAC fluid from 15 degrees Fahrenheit to 160 degrees Fahrenheit. Even if achieving this kind of temperature difference with a single heat pump were feasible (which it most likely is not), the required energy input would be significantly greater than it would be for the incremental approach discussed herein. In some embodiments, the temperature of domestic hot water can be raised to 140 degrees Fahrenheit and process water to 160 degrees Fahrenheit. Thus, in many instances, multiple heat pumps arranged in a series relationship can provide additional functionality, improved system reliability, reduced wear on components, and increased efficiency.

Arranging multiple heat pumps in a series relationship can provide certain advantages in some embodiments. In many embodiments, each heat pump that is arranged in a series relationship experiences less strain than a single heat pump designed to achieve the same total temperature difference. In many such embodiments, the multiple heat pumps arranged in series provide for increased durability and longevity. In some embodiments, heat pumps that are optimized for certain temperature ranges can be selected. For example, in the example provided above, the first heat pump can be configured for peak efficiency between 15 and 60 degrees Fahrenheit, the second heat pump can be configured for peak efficiency between 60 and 120 degrees Fahrenheit, and the third heat pump can be configured for peak efficiency between 120 and 160 degrees Fahrenheit. A heat pump can be optimized for a given temperature range by adjusting one or more of a variety of factors. For example, different heat pump refrigerants can be used in each of the ranges, with each heat pump refrigerant having characteristics making it suitable for optimal efficiency within a given temperature range. Different heat pumps can operate at different pressures and/or with different heat pump refrigerant volumes to provide optimum operation within different temperature ranges. Though arranging multiple heat pumps in a series relationship has been discussed in connection with progressively increasing the temperature of HVAC fluid in heating operations, the same kind of arrangement can progressively decrease the temperature of HVAC fluid in cooling operations.

Referring again to FIG. 1A, the illustrative HVAC system includes energy transfer components, as noted above. One of the energy transfer components shown in FIG. 1A is a solar thermal panel 10, which can assist the heat pump 8 in heating operations. The solar thermal panel 10 of FIG. 1A includes four panels 30 that collect solar thermal energy (though any number of panels 30 are possible). Solar radiant energy passes through the glass cover of the panel and is entrapped within the panel space. The solar radiant heat that accumulates in the panel is absorbed and transferred from the panel space to the radiant fins. The energy absorbed by the fins dissipates to the attached piping at its center. The energy transferred to the piping can be absorbed by the HVAC fluid that is passing through the pipes. In this way, HVAC fluid exiting the solar thermal panel 10 can be warmer than HVAC fluid entering the solar thermal panel 10, thereby reducing the amount by which the heat pump 8 must work to heat the relevant HVAC fluid to effectuate the desired heating. In some embodiments, such as that of FIG. 1A, the solar thermal panel 10 can be connected to the main loop 50. In some embodiments, the solar thermal panel 10 can be connected directly to the heat pump 8. In some embodiments, the solar thermal panel 10 can be connected to the domestic hot water supply, either instead of the HVAC fluid or in addition to the HVAC fluid (e.g., by running alternate piping circuits or the use of a heat exchanger on a separate solar panel piping). Taking advantage of heat provided by the solar thermal panel 10 can allow HVAC systems to perform significantly more efficiently and sustainably.

The HVAC system of FIG. 1A includes a laundry heat transfer component 12 and a waste water heat transfer component 14 as energy transfer components. The laundry heat transfer component 12 can take advantage of laundry exhaust (e.g., dryer exhaust) that is at a significantly higher temperature than the heat recovery HVAC fluid. In many buildings, laundry exhaust is channeled to the outside and into the surrounding air without the HVAC system taking advantage of its heat. The waste water heat transfer component 14 can take advantage of waste water (e.g., from laundry process water, shower drains, water closets, sink drains, etc.) that is at a significantly higher temperature than the heat recovery HVAC fluid. For example, the water running through shower drains is often around 90 degrees Fahrenheit. In some embodiments, such as that of FIG. 1A, both the laundry heat transfer component 12 and the waste water heat transfer component 14 can be connected to the main loop 50. In some embodiments, either one or both of the laundry heat transfer component 12 and the waste water heat transfer component 14 can be connected directly to the heat pump 8. Recovering this heat and using it in a building's HVAC system can significantly offset heating loads, increase heat pump efficiency, along with regenerating heat sources and providing a more sustainable system.

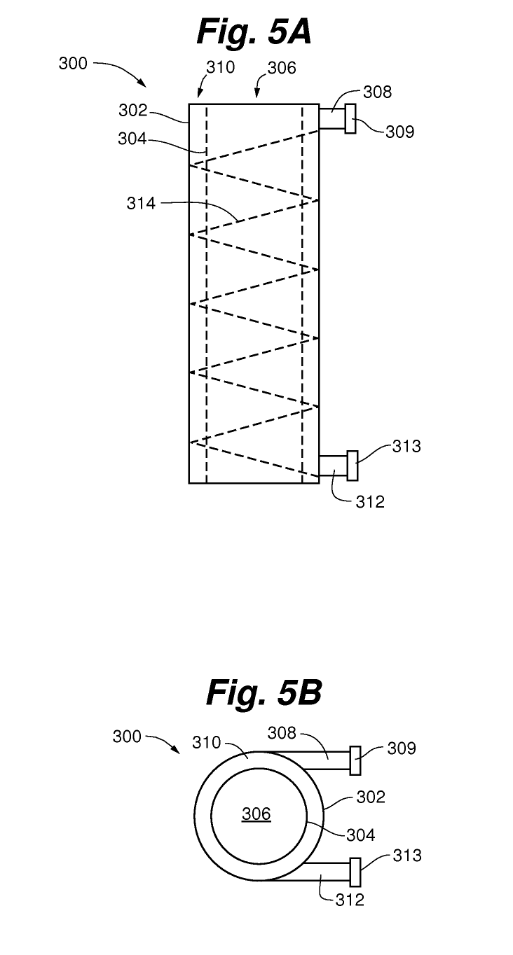

In many embodiments, the laundry heat transfer component 12 and the waste water heat transfer component 14 can have substantially the same flow-through structure. FIGS. 5A-5B show an example of such a structure. The flow-through heat transfer component 300 can include two coaxial tubes 302, 304. Laundry exhaust or waste water can pass through the interior of the inner tube 304, through channel 306. In many embodiments, the flow-through heat transfer component 300 can be substituted for a section of piping in a laundry exhaust or a waste water drainage system, with the inner diameter of tube 304 being smooth walled and substantially the same as the inner diameter of the laundry exhaust or waste water drainage system pipe. In this way, the flow path of the waste water or laundry exhaust can be substantially unimpeded by the structure that channels the HVAC fluid through the flow-through heat transfer component 300. This can provide a significant advantage over conventional plate-and-frame components in that solid substances (e.g., laundry lint, human waste, bones from kitchen drains, etc.) do not get trapped in the HVAC structure, meaning that the heat can be recovered without hindering the functionality of the laundry exhaust or waste water systems.

The flow-through heat transfer component 300 of FIGS. 5A-5B includes an inlet pipe 308 and a corresponding inlet connector 309, as well as an outlet pipe 312 and a corresponding outlet connector 313. The inlet and outlet connectors 309, 313 can connect the flow-through heat transfer component 300 to HVAC pipes, thereby incorporating the flow-through heat transfer component 300 into an HVAC system. Once connected, HVAC fluid can enter the flow-through heat transfer component 300 through the inlet pipe 308 and then pass into the channel 310 between the exterior of the inner tube 304 and the interior of the outer tube 302. As the HVAC fluid flows within the channel 310 from the inlet pipe 308 toward the outlet pipe 312, a barrier 314 guides HVAC fluid around and around the inner tube 304 in a coil-like configuration. In many embodiments, this flow path lengthens the amount of time the HVAC fluid is within the flow-through heat transfer component 300 and in thermal conductance with the laundry exhaust or waste water. In many embodiments, this flow path increases the turbulence of the flowing HVAC fluid, thereby enhancing the heat transfer of the HVAC fluid. When the HVAC fluid has completed its path through the channel 310 along the barrier 314, it exits the flow-through heat transfer component 300 through the outlet pipe 312. The HVAC fluid exiting the flow-through heat transfer component 300 through the outlet pipe 312 can be at a significantly higher temperature than the HVAC fluid entering the flow-through heat transfer component 300 through the inlet pipe 308.

The wall of the inner tube 304 can be configured to permit maximum heat transfer between the laundry exhaust or waste water and the HVAC fluid (e.g., can be made of thermally conductive material, such as a metal). The thickness of the wall of the inner tube 304 can relate to the thermal capacitance and absorptivity from the inner heat source, which could flow in either direction. The wall of the outer tube 302 can be made of thermally insulating material (e.g., a type of plastic) or an insulated metal, thereby inhibiting heat transfer between the HVAC fluid and the environment surrounding the flow-through heat transfer component 300. Many factors can be controlled to facilitate maximum heat transfer, such as contact surface area, direction of source flow, HVAC fluid flow rate, source flow rate, HVAC fluid temperature, and so on. In this way, the heat from the laundry exhaust or the waste water can be recovered and used in the HVAC system, allowing the HVAC system to perform more efficiently and sustainably. In some embodiments, the flow-through heat transfer component 300 can be used in reverse to heat the fluid within channel 306. In some embodiments, one or both of the inner and outer flows may be reversed. The insulating and conducting materials can be interchanged or made of the same material.

Referring again to FIG. 1A, the illustrative HVAC system can include a ground energy transfer component 16. In certain ground conditions, it is advantageous for the HVAC system to include pipes that exit the building and pass through a portion of the ground to take advantage of ambient ground energy. In some embodiments, such as that of FIG. 1A, the ground energy transfer component 16 can be connected to the main loop 50. In some embodiments, the ground energy transfer component 16 can be connected directly to the heat pump 8. Recovering this energy and using it in a building's HVAC system can significantly increase efficiency, along with providing a more sustainable system.

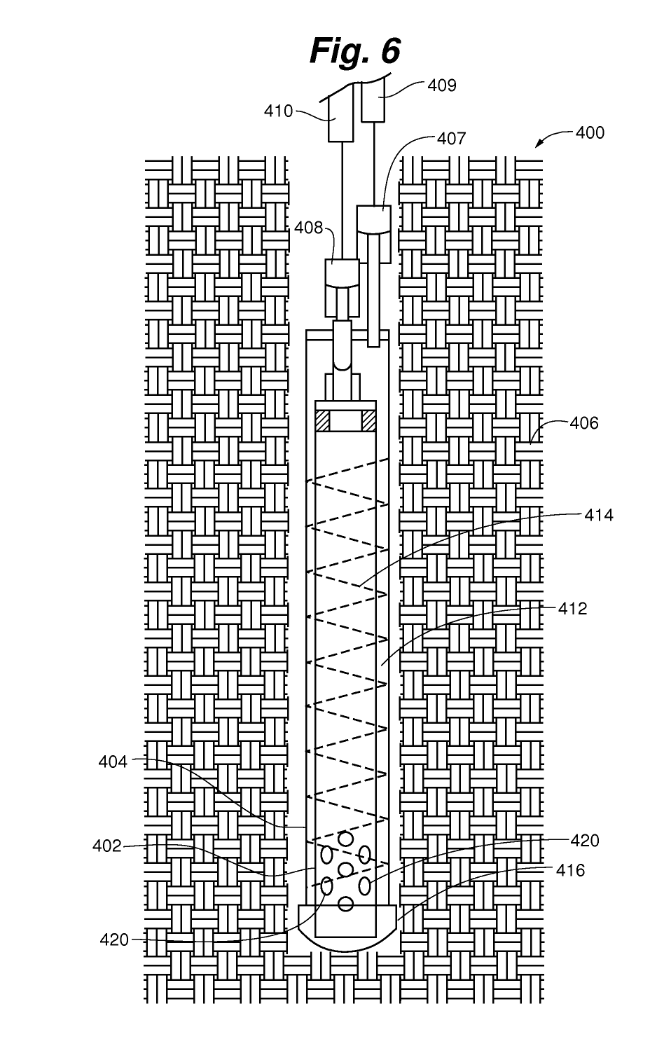

FIG. 6 shows an illustrative ground energy transfer component 400, according to some embodiments of the present invention. Like the flow-through heat transfer component of FIGS. 5A-5B, the ground energy transfer component 400 of FIG. 6 includes two coaxial tubes 402, 404. The tubes 402, 404 are shown positioned in the ground 406. In some embodiments, the tubes 402, 404 can be positioned in water or in any other suitable thermal mass. In many embodiments, the inner tube 402 is made of a material that is relatively thermally insulative (e.g., High Density Polyethylene [HDPE] plastic piping). In many embodiments, the outer tube 404 is made out of material that is relatively thermally conductive (e.g., stainless steel). The outer surface of the outer tube 404 may have a thin moisture barrier. Reasons for making the inner tube 402 of thermally insulative material and/or the outer tube 404 of thermally conductive material are discussed in greater detail elsewhere herein.

The ground energy transfer component 400 of FIG. 6 includes an inlet connector 407 and an outlet connector 408. The inlet connector 407 can connect to an inlet pipe 409 of an HVAC system, and the outlet connector 408 can connect to an outlet pipe 410 of the HVAC system, thereby incorporating the ground energy transfer component 400 into the HVAC system. In many embodiments, the inlet pipe 409 and the outlet pipe 410 can be made of a plastic polymer, such as a high-density polyethylene. As noted above, the outer tube 404 is often made of metal, meaning that the inlet connector 407 and the outlet connector 408 often have components that permit the polymer HVAC pipes to interface with the metal exterior of the ground energy transfer component.

In many embodiments, HVAC fluid can enter the ground energy transfer component 400 from the inlet pipe 409 through inlet connector 407 and can exit through the outlet connector 408 into the outlet pipe 410. In some embodiments, HVAC fluid can enter the ground energy transfer component 400 from the outlet pipe 410 through the outlet connector 408 and exit through the inlet connector into the inlet pipe 409. In many embodiments, the cross-sectional area of the connector by which the HVAC fluid enters the ground energy transfer component can be smaller than the cross-sectional area of the corresponding HVAC pipe, thereby resulting in an increased flow velocity of the HVAC fluid. In many embodiments, the flow volume of the HVAC fluid entering the ground energy transfer component is substantially equal to the flow volume of the HVAC fluid exiting the ground energy transfer component.

When HVAC fluid enters the ground energy transfer component 400 from the inlet pipe 409 via the inlet connector 407, the HVAC fluid can flow downwardly in the channel 412 between the outer surface of the inner tube 402 and the inner surface of the outer tube 404. As the HVAC fluid flows downwardly within the channel 412, a barrier 414 guides the HVAC fluid around and around the inner tube 402 in a coil-like configuration. In many embodiments, the barrier 414 serves to maintain the inner tube 402 in a generally concentric relationship with the outer tube 404. In many embodiments, the barrier 414 can be constructed of deformable tubing (e.g., plastic or metal). In some embodiments, the tubing can be wrapped around the inner tube 402 to create coils in a desired configuration. The tubing can be hot-air welded to the inner tube 402 to substantially prevent HVAC fluid from flowing straight down in the channel 412 as opposed to along the barrier 414.

The HVAC fluid completes its path through the channel 412 along the barrier 414 as it approaches the base 416 of the ground energy transfer component 400. As the HVAC fluid approaches and reaches the base 416, it enters the interior of the inner tube 402. In many embodiments, HVAC fluid enters the interior of the inner tube 402 through holes 420. In some embodiments, the lower end of the inner tube 402 can be open, which can permit HVAC fluid to enter the interior of the inner tube 402 through that opening. In some embodiments, the inner tube 402 can have both holes 420 and an open lower end. In embodiments having holes 420 and a closed lower end, the inner tube 402 can be connected to the base 416 in a substantially rigid manner, thereby reducing the tensile stress on the plastic-to-metal or metal-to-metal adapters of the inlet connector 407 and the outlet connector 408. In many embodiments, the collective cross-sectional area of the holes 420 is greater than the cross sectional area of the interior of the inner tube 402, thereby permitting ease of passage. In some embodiments, the holes 420 can be arranged approximately symmetrically about the inner tube 402. In this way, the flow momentum of the HVAC fluid can be balanced due to flow through the each hole 420 being countered by flow through one or more opposite holes 420.

The HVAC fluid then flows relatively laminarly upward in the interior of the inner tube 402. The cross-sectional area of the interior of the inner tube 402 can be significantly greater than the cross-sectional area within the channel 412. In this way, flow velocity within the inner tube 402 can be reduced, thereby producing a more laminar flow. In many embodiments, the HVAC fluid contacts significantly less surface of the ground energy transfer component on the upward path than on the downward path. Similarly, in most embodiments, the HVAC fluid can flow substantially unimpeded by other surfaces within the inner tube 402, thereby producing a more laminar flow. The upward path is also generally a significantly shorter distance, without spiraling around the ground energy transfer component 400. The HVAC fluid then exits the ground energy transfer component 400 through the outlet connector 408 and flows back into the outlet pipe 410. In such an embodiment, because the vertical temperature gradient of the surrounding ground 406 is opposite to that of the HVAC fluid in channel 412—during both heating and cooling—the ground energy transfer component 400 can serve as a cross-flow heat exchanger with the ground or ground fluid.

As referenced above, the HVAC fluid can thermally react with the ground 406 while in the ground energy transfer component 400. The HVAC fluid within channel 412, as guided by barrier 414, can thermally react with the ground. In many embodiments, this flow path increases the amount of time that the HVAC fluid is in thermal communication with the surrounding ground 406. In some embodiments, the momentum of the HVAC fluid as it flows along the barrier 414 causes it to crash against the interior of the outer tube 404. This turbulence can result in greater heat transfer between the HVAC fluid and the surrounding ground 406. Turbulence can be increased by providing increased flow velocity of the HVAC fluid; subjecting the HVAC fluid to more frictional forces due to contacting the barrier 414, the inner tube 402, and the outer tube 404; and/or by subjecting the HVAC fluid to a greater degree of centripetal force. As the HVAC fluid contacts the barrier 414, the inner tube 402, and the outer tube 404, it should be noted that the outer tube 404 provides a larger surface area for heat transfer to occur and that the HVAC fluid is contacting at the peak of its centripetal velocity profile.

In some instances, the HVAC fluid recovers heat from the ground 406, resulting in HVAC fluid that is warmer near the base 416 than the HVAC fluid near the inlet connector 407. In some instances, the HVAC fluid dissipates heat to the ground 406, resulting in HVAC fluid that is cooler near the base 416 than the HVAC fluid near the inlet connector 407. Generally, the HVAC fluid recovers heat from the ground 406 when the ground 406 is warmer than the HVAC fluid, and the HVAC fluid dissipates heat to the ground 406 when the ground 406 is cooler than the HVAC fluid. In many instances, the HVAC fluid recovers heat from the ground when the HVAC system is heating, and the HVAC fluid dissipates heat to the ground when the HVAC system is cooling. The wall of the outer tube 404 can be configured to permit maximum heat transfer between the HVAC fluid and the ground 406 (e.g., can be made of thermally conductive material, such as stainless steel).

The heat transfer properties can be enhanced by the surface properties of the barrier 414, the angle of slope (pitch) of the barrier 414, the size of the passageway between two sections of the barrier 414, the flow rate of the HVAC fluid, the centrifugal forces, other factors, or combinations thereof. In some embodiments, the spaces between coils of the barrier 414 can be non-uniform. For example, a single ground energy transfer component can have some coils that are spaced further apart (e.g., in ground with a higher recovery rate, such as an underground stream; in ground with a convective heat transfer component, such as flowing waste water) and other coils that are closer together (e.g., in ordinary ground with a lower heat recovery rate). In this way, the ground energy transfer component 400 can be tuned to the ground conditions by adjusting the pitch of the barrier 414.

In many embodiments, the HVAC fluid in the interior of the inner tube 402 can be generally thermally insulated, resulting in a relatively constant temperature within the interior of the inner tube 402. The wall of the inner tube 402 can be made of thermally insulating material, thereby inhibiting heat transfer between the HVAC fluid flowing through channel 412 and the HVAC fluid flowing in the interior of the inner tube 402. The spiraling flow path can create a velocity profile at the interface between the inner tube 402 and the HVAC fluid is relatively small, thereby resulting in less heat transfer between the HVAC fluid in channel 412 and the HVAC fluid in the interior of the inner tube 402.

Insulating the HVAC fluid within the interior of the inner tube 402 can generally preserve the effect of the heat transfer that occurred while HVAC fluid was flowing through channel 412. In some embodiments, a small amount of heat may transfer between HVAC fluid flowing within the inner tube 402 to HVAC fluid flowing within the outer tube 404. In such embodiments, the heat is transferred within the system, meaning that the heat is not lost to the surrounding environment. Providing both a heat transfer path and a return insulated path (or vice versa) can provide several advantages, such as improving the total heat transfer, reducing the volume of fluid, and improving the HVAC system response rate. In this way, embodiments of the ground energy transfer component 400 can be easily integrated into HVAC systems. The ground energy transfer component 400 can aid in recovering energy from the ground 406 (e.g., ground having the above-mentioned ground conditions) to be used in HVAC systems.

In some embodiments, the flow path through the ground energy transfer component 400 can be reversed. HVAC fluid can enter the ground energy transfer component 400 from the outlet pipe 410 via the outlet connector 408, flow downwardly within the interior of the inner tube 402 toward base 416, flow back upwardly through channel 412 (while recovering heat from the ground 406 or dissipating heat to the ground 406), and then exit the ground energy transfer component 400 to the inlet pipe 409 via the inlet connector 407.

Embodiments of the ground energy transfer component 400 can provide one or more of the following advantages. Some embodiments are closed systems, meaning that they can accommodate HVAC fluids such as antifreeze while remaining environmentally friendly. As closed systems, the HVAC fluid is not affected by ground or water minerals. In such embodiments, the welds in the outer tube and base can be air tight, as can the relevant connectors. Some embodiments provide more efficient heat transfer as compared with some closed geothermal wells. Some embodiments provide equal or better heat transfer as compared with open geothermal wells, but without environmental exposure to the ground or mineral exposure to the HVAC system. This increased efficiency can permit ground energy transfer components that are significantly shorter than geothermal wells. For example, many ground energy transfer component embodiments are less than 50 feet long. Many ground energy transfer component embodiments come in standard pipe lengths (e.g., 21 feet, etc.). Many ground energy transfer component embodiments are capable of fitting within a single (e.g., 6-inch diameter) bore hole. Some embodiments have a significantly smaller footprint than most conventional horizontal geothermal wells, some of which may be buried in relatively shallow ground. Some embodiments, such as those having outer tubes made of mill grade stainless steel, can provide significantly enhanced durability. Some embodiments can be used in connection with relatively small pumping heads and/or can operate at relatively low flow rates. Some embodiments are relatively inexpensive and/or simple to manufacture (e.g., due to the simple construction, the wide availability of base materials, etc.). Some embodiments provide the above-noted heat transfer benefits without diminishing the appearance of the building into which they are incorporated (e.g., they have no rejection towers, propane tanks, exhaust stacks, etc.).

Many ground energy transfer components can be installed with relative ease. For example, a 4-inch hollow-stem auger can be inserted into the ground at a desired depth. The ground energy transfer component can then be slid into the interior of the auger. The auger can then be removed from the hole, leaving the ground energy transfer component intact. This can permit installation in even wet ground conditions. It can also reduce or eliminate the need for holding the hole open during installation. In installing ground energy transfer components in rock, a 3.7-inch cored hole can be used, thereby reducing the required amount of rock drilling. In many instances, the ground energy transfer component can be pre-fabricated, thereby simplifying on-site installation. A variety of installation methods can be employed.

Some HVAC systems include multiple ground energy transfer components 400. Multiple ground energy transfer components are arranged in series in some systems. Multiple ground energy transfer components are arranged in parallel in some systems. Some parallel arrangements provide advantages, such as reduced resistance to flow in the HVAC system and thus lower pumping costs.

Some embodiments of the ground energy transfer component can be used in applications other than HVAC systems. Examples include heaters for intakes of hydroelectric power dams, industrial processes, and other suitable applications.

Referring again to FIG. 1A, one of the energy transfer components of the illustrative HVAC system is a geothermal well system 18. The geothermal well system 18 can channel HVAC fluid down deep below the surface of the earth. In many embodiments, the geothermal well system 18 includes one or more loops 44, each comprising two pipes connected on their lower ends by a connector. Often, the loops 44 extend roughly 150-400 feet below the surface of the earth, where the temperature remains relatively constant. For much of the northern United States, this temperature is around 45 degrees Fahrenheit. The geothermal well system 18 can be made of thermally conductive material, thereby encouraging heat transfer between the HVAC fluid running through the geothermal well system 18 and the ground. In many embodiments, the geothermal well system 18 can be made of plastic pipe, which can have limited thermal conductivity. Generally, in heating operations, heat can be transferred from the ground to the HVAC fluid, and in cooling operations, heat can be transferred from the HVAC fluid to the ground. In some embodiments, such as that of FIG. 1A, the geothermal well system 18 can be connected to the main loop 50. In some embodiments, the geothermal well system 18 can be connected directly to the heat pump 8. In this way, the HVAC system can take advantage of the relatively constant temperature beneath the earth's surface, allowing the HVAC system to perform more efficiently and sustainably.

One of the energy transfer components of the illustrative HVAC system of FIG. 1A is an outdoor air energy transfer component 20. In many embodiments, it is advantageous to channel HVAC fluid through pipes that are exposed to outdoor ambient air. For example, in cooling the interior playing surface of an ice arena (e.g., to 20 degrees Fahrenheit) during peak winter and/or during cold “off-electrical peak” evenings when the air is colder than 20 degrees Fahrenheit, the HVAC system can dissipate significant amounts of heat to the outdoor ambient air while chilling the HVAC fluid used for cooling the interior playing surface of an ice arena. During the times when making ice with compressor work, the warm HVAC fluid can dissipate its heat from the compressors. In some embodiments, the outdoor air energy transfer component 20 is a closed loop that conserves water and does not evaporate it. The HVAC fluid can pass through the outdoor air energy transfer component 20, and a fan 46 can blow outdoor ambient air across the pipes containing HVAC fluid. In some embodiments, such as that of FIG. 1A, the outdoor air energy transfer component 20 can be connected to the main loop 50. In some embodiments, the outdoor air energy transfer component 20 can be connected directly to the heat pump 8. In this way, the HVAC system can take advantage of the outdoor ambient air, allowing the HVAC system to perform more efficiently and sustainably. In some situations, the outdoor air energy transfer component 20 can be used in enclosed spaces that simultaneously achieve a desired effect on the ambient air and the HVAC fluid.

One energy transfer component of the illustrative HVAC system of FIG. 1A is an exhaust heat transfer component 22. In many instances, various kinds of exhaust (e.g., building relief air, parking garage exhaust, general exhaust, non-grease kitchen exhaust, kiln exhaust, etc.) is removed buildings without taking advantage of the exhaust's thermal properties. HVAC fluid can be channeled around a coil within the exhaust heat transfer component 22. Exhaust can pass by the coil, thereby thermally reacting with the HVAC fluid. In this way, HVAC fluid exiting the exhaust heat transfer component 22 can be warmer than HVAC fluid entering the exhaust heat transfer component 22, thereby reducing the amount by which the heat pump 8 must heat the relevant HVAC fluid to effectuate the desired heating. In some embodiments, such as that of FIG. 1A, the exhaust heat transfer component 22 can be connected to the main loop 50. In some embodiments, the exhaust heat transfer component 22 can be connected directly to the heat pump 8. In some embodiments, the exhaust heat transfer component 22 can be connected to HVAC fluid that is warmer than the exhaust air in order to reject heat from the HVAC system. In this way, the HVAC system can take advantage of the thermal properties of the otherwise unused exhaust, allowing the HVAC system to perform more efficiently and sustainably.

One energy transfer component of the illustrative HVAC system of FIG. 1A is a domestic cold water heat exchanger 24. In many instances, the domestic cold water provided to a building (e.g., from a municipality) is warmer than it needs to be and/or warmer than desired. For example, domestic cold water is often provided at 45 degrees Fahrenheit and warmer, while cold water coming out of the tap is commonly (and often preferably) only 37 degrees Fahrenheit. Accordingly, the domestic cold water heat exchanger 24 can reduce the temperature of the domestic cold water while providing the excess heat to the HVAC fluid flowing through the domestic cold water heat exchanger 24. In this way, HVAC fluid exiting the domestic cold water heat exchanger 24 can be warmer than HVAC fluid entering the domestic cold water heat exchanger 24, thereby reducing the amount by which the heat pump 8 must heat the relevant HVAC fluid to effectuate the desired heating. In this way, the domestic cold water can be made biologically safer and can be made usable for cooling applications. In some embodiments, such as that of FIG. 1A, the domestic cold water heat exchanger 24 can be connected to the main loop 50. In some embodiments, the domestic cold water heat exchanger 24 can be connected directly to the heat pump 8. In this way, the HVAC system can take advantage of the heat provided by cooling the domestic cold water, allowing the HVAC system to perform more efficiently and sustainably.

In the illustrative HVAC system of FIG. 1A, the above-mentioned network of pipes and valves can distribute temperature-controlled HVAC fluid to the illustrated building zones 2, 4. Before the HVAC fluid flows to the building zones 2, 4, the HVAC fluid can flow through respective distribution boxes 26, 28. As discussed elsewhere herein, many buildings have several zones, such as 20, 30, 40, or more zones. For example, in a hotel, each room can constitute its own zone. In many embodiments of the present invention, one distribution box is provided for each building zone. The distribution boxes 26, 28 can provide more precise temperature control to the building zones 2, 4. Moreover, as is discussed elsewhere herein, many distribution boxes 26, 28 are indeed modular in that they can be easily exchanged in their entirety if one or more of the components therein needs to be repaired or replaced. In this way, the relevant building zone can be isolated from the HVAC system (e.g., by shutting inlet and outlet HVAC fluid valves) for only the relatively short period of time required to exchange the distribution box, as opposed to isolating that building zone for the often much longer period of time required to repair or replace the relevant component(s). With the distribution box removed from the HVAC system, the relevant component(s) can be repaired or replaced in a shop location, thereby preparing the distribution box to be reintroduced to an HVAC system. The distribution box can be reintroduced to the same HVAC system (in the same or different location) or in an entirely different HVAC system.

In many instances, it is advantageous to build a complete distribution box in a setting more conducive to construction (e.g., a machine shop), as opposed to interconnecting the various components at the same time as installing the HVAC system. In many such instances, the setting more conducive to the construction may be located remotely from the HVAC system installation site. The setting may employ more specifically trained or alternately waged people to perform the task.

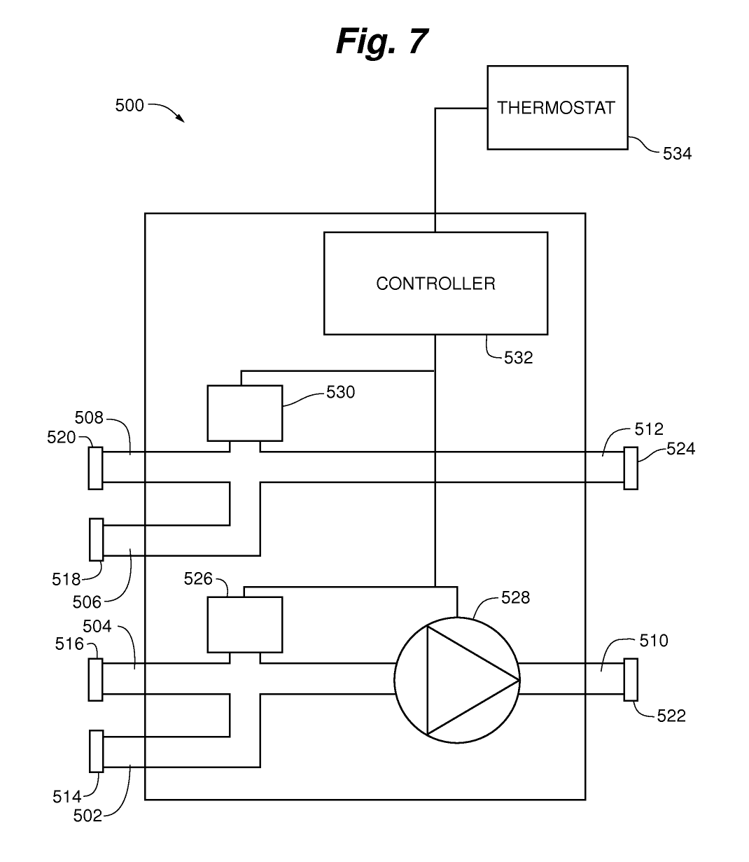

FIG. 7 shows an illustrative distribution box 500, according to some embodiments of the present invention. As shown, the distribution box 500 can include a hot HVAC fluid inlet pipe 502, a cold HVAC fluid inlet pipe 504, a hot HVAC fluid outlet pipe 506, and a cold HVAC fluid outlet pipe 508. Each of the inlet and outlet pipes 502, 504, 506, 508 can have a corresponding connector. Connector 514 can be connected to the hot HVAC fluid inlet pipe 502, connector 516 can be connected to the cold HVAC fluid inlet pipe 504, connector 518 can be connected to the hot HVAC fluid outlet pipe 506, and connector 520 can be connected to the cold HVAC fluid outlet pipe 508. The distribution box 500 can include a fan coil supply pipe 510 and a fan coil return pipe 512. Both of the fan coil pipes 510, 512 can have a corresponding connector, with connector 522 being connected to the fan coil supply pipe 510 and connector 524 being connected to the fan coil return pipe 512. The fan coil pipes 510, 512 can enable the distribution box 500 to be connected to a fan coil and/or to various HVAC terminal devices.

The connectors 514, 516, 518, 520, 522, 524 of the distribution box 500 can connect to HVAC pipes, thereby incorporating the distribution box 500 into an HVAC system. In many embodiments, the connectors 514, 516, 518, 520, 522, 524 of the distribution box 500 can be configured to permit the distribution box 500 to be connected to, and disconnected from, the remainder of the HVAC system relatively quickly.

As noted, HVAC fluid can flow through the distribution box 500. HVAC fluid can flow into the distribution box 500 via the hot HVAC fluid inlet pipe 502 and/or the cold HVAC fluid inlet pipe 504. A valve 526 can permit either hot HVAC fluid coming from the hot HVAC fluid inlet pipe 502 or cold HVAC fluid coming from the cold HVAC fluid inlet pipe 504 to pass through to pump 528. Pump 528 can pump the relevant HVAC fluid through the fan coil supply pipe 510 and into a fan coil. In some embodiments, the HVAC fluid can flow into the fan coil without the need of pump 528 (e.g., if the rest of the HVAC system is designed to provide the requisite pressure). After passing through the fan coil, the HVAC fluid can re-enter the distribution box via the fan coil return pipe 512. A valve 530 can channel the HVAC fluid out of the distribution box 500 via either the hot HVAC fluid outlet pipe 506 or the cold HVAC fluid outlet pipe 508. The valves 526 and 530 can be configured such that hot HVAC fluid and cold HVAC fluid do not mix. Hot HVAC fluid from HVAC fluid inlet pipe 502 can return to the hot HVAC fluid at hot HVAC fluid outlet pipe 506. Cold HVAC fluid from cold HVAC fluid pipe 504 can return to the cold HVAC fluid at cold HVAC fluid outlet pipe 508.

A controller 532 can control various aspects of the distribution box 500. The controller 532 can be in electrical communication with one or more inputs, such as thermostat 534. Thermostat 534 can be positioned within the appropriate zone. One or more individuals within the zone can manually adjust conditions of the zone via thermostat 534, or thermostat 534 can operate according to various pre-selected conditions. Other inputs that can be in electrical communication with the controller 532 include various sensors. For example, a temperature sensor can be positioned in the fan coil supply pipe 510 such that the temperature sensor can inform the controller 532 of the temperature of the HVAC fluid entering the fan coil. Several other inputs are used in various embodiments.

Based on information provided by one or more inputs, the controller 532 can control various aspects of the distribution box 500. For example, the controller 532 can instruct valve 526 to permit only hot HVAC fluid to pass through to the pump 528 (e.g., during a heating operation) or to permit only cold HVAC fluid to pass through to the pump 528 (e.g., during a cooling operation). In some instances, the controller 532 can control the flow rate and/or displacement of the pump 528. In some instances, the pump 528 and be a multi-speed (e.g., 3-speed) pump, and the controller 532 can control which of speed is selected for operation. In some embodiments, the controller 532 can instruct valve 530 to channel returning HVAC fluid through the hot HVAC fluid outlet pipe 506 (e.g., during a heating operation) or through the cold HVAC fluid outlet pipe 508 (e.g., during a cooling operation). In some instances, the controller 532 can (digitally) instruct the blower of the fan coil to various pre-wired stages of speed or it can instruct the blower of the fan coil to any increment of speed on a variable (analogue) signal.

Like other controllers discussed herein, the controller 532 can be implemented in digital electronic circuitry, integrated circuitry, specially designed ASICs (application specific integrated circuits), computer hardware, firmware, software, electric relays and switches and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These various implementations can include relays and switches from a remote controller device (e.g., a thermostat) wired or wirelessly connected to the assembled body of an embodiment of the invention.

In many instances, the controller can be connected via a network (e.g., a LAN, a WAN, the Internet, etc.) to other components of the HVAC system. Examples of components to which the controller 532 may be connected include controllers of other distribution boxes, controllers for one or more of the various energy transfer components, controllers for one or more heat pump, operator input devices/stations, zone input sensors (e.g., a sensor to indicate whether the zone has transitioned from a closed system to an open system, such as through the opening of a door or window), and other suitable components. In this way, an operator (e.g., a hotel employee at the front desk) can provide instructions to the controller 532, such as whether the zone is occupied, one or more set-point temperatures for the zone, changes to the set-point temperature or limit set points, changes to the actual temperature, whether to cease heating/cooling in the zone, and so on. In this way, the operator can remotely control various HVAC conditions within a given zone with relative ease.

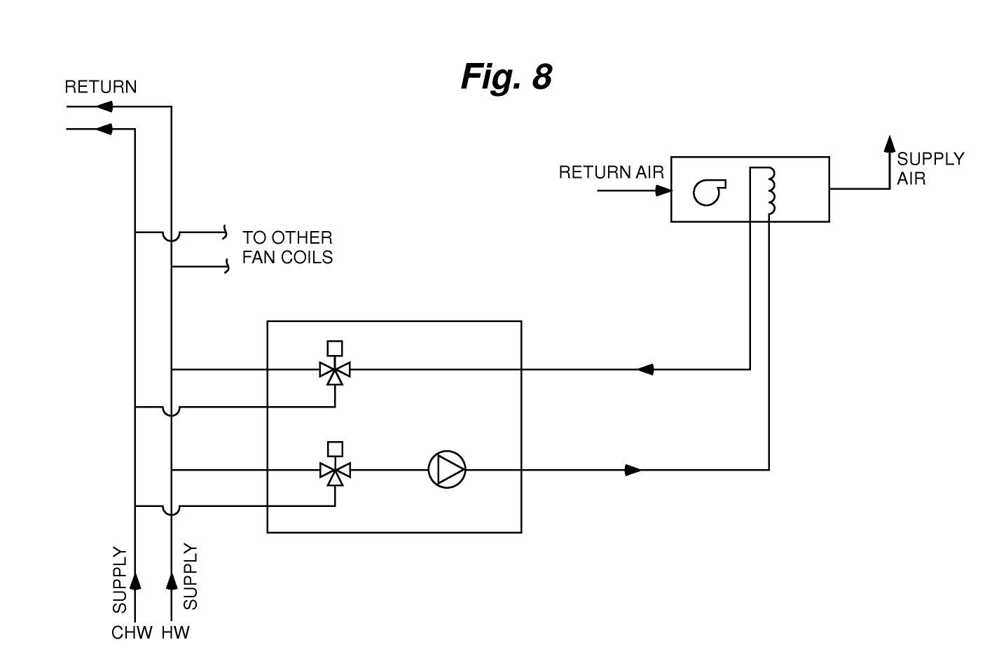

In many HVAC system embodiments in which a controller and corresponding pump(s) and valve(s) regulate the HVAC fluid entering the fan coil, the HVAC fluid can enter only one coil within the fan box, as opposed to two separate coils (one for cold HVAC fluid and the other for hot HVAC fluid). FIG. 8 illustrates such a system. Such a system can provide one or more of several advantages. Some such systems can accommodate potable water as the HVAC fluid in that there is a significantly lower likelihood that water will remain stagnant in the fan coil. The controller can cause the pump to regularly circulate the water in and through the fan box, thereby preventing the water from becoming stagnant. This contrasts with many two-coil systems in which water can remain stagnant for six months or more (e.g., hot water in the hot water coil during a long cooling season), leading to contamination and/or unacceptable temperatures. Regularly circulating the water can dramatically reduce the risk of contamination of the potable HVAC fluid, as well as maintain the water at an acceptable temperature (e.g., hot water above 115 degrees Fahrenheit). Some such systems can reduce the likelihood of simultaneously heating and cooling a zone, thereby reducing inefficiencies. Some such systems incorporate one larger size coil, which can accomplish heating or cooling with HVAC fluid at lower or higher temperatures, respectively. Some such systems can operate in the absence of the heat pump in some circumstances (e.g., when the one or more energy transfer components are capable of providing HVAC fluid at the desired temperatures). Some such systems can operate effectively by one or more smaller fans (e.g., having only one coil as opposed to two coils can reduce the static pressure drop that the fan must overcome, allowing the fan to be smaller and often using less energy and producing less noise).

Referring again to FIG. 7, in some embodiments, the distribution box 500 is configured to accommodate potable water. Valves, pumps, and other components can be constructed out of materials (e.g., bronze, stainless steel, etc.) that do not erode in such a way as to contaminate the potable water. Such systems can include a bronze body circulating pump (e.g., Grundfos UP15-42 B7 or UP26-96 BF). The pumps can be 100% lead free circulators suitable for potable water systems with 145 psi maximum operating pressure and 176 degrees Fahrenheit maximum fluid temperature in a 104 degrees Fahrenheit maximum ambient temperature. In some embodiments, the pumps can accommodate water from just above freezing (e.g., 35.6 degrees Fahrenheit) up to approximately 230 degrees Fahrenheit. Some embodiments include a composite impeller suitable for potable water. Many other variations are possible. Systems that accommodate potable water often circulate the water to prevent stagnation, whether or not circulation is needed for HVAC purposes.

Distribution components similar to the distribution box 500 of FIG. 7 can be incorporated into other locations in HVAC systems. For example, some energy transfer components can be used in both heating and cooling operations. Examples from FIG. 1A include the ground energy transfer component 16, the geothermal well system 18, the outdoor air energy transfer component 20, and the exhaust heat transfer component 22. A distribution box can be connected between such energy transfer components and, e.g., the main loop 50. Such a distribution box can include one or more valves, controllable by a controller, that channel either hot HVAC fluid (e.g., during heating operations) or cold HVAC fluid (e.g., during cooling operations) through the energy transfer component. Some distribution boxes that are incorporated into other locations in HVAC systems can have similar characteristics to the distribution box of FIG. 7, meaning that they can be swapped out quickly and efficiently.

As discussed herein, a first aspect of the present invention provides a device for enabling an HVAC component to be easily connected to, and disconnected from, an HVAC system. The device can include a modular distribution box, hot and cold HVAC fluid inlet pipes, HVAC component supply and HVAC component return pipes, and hot and cold HVAC fluid outlet pipes, each of which can be coupled to the modular distribution box, and each of which can have a connector. The hot HVAC fluid inlet pipe's connector can be configured to connect to a hot HVAC pipe, and the cold HVAC fluid inlet pipe's connector can be configured to connect to a cold HVAC pipe. The HVAC component supply pipe's connector can be configured to connect to an inlet pipe of the HVAC component, and the HVAC component return pipe's connector can be configured to connect to an outlet pipe of the HVAC component. The hot HVAC fluid outlet pipe's connector can be configured to connect to the hot HVAC pipe, and the cold HVAC fluid outlet pipe's connector can be configured to connect to the cold HVAC pipe. The hot and cold HVAC fluid inlet pipes, the HVAC component supply and HVAC component return pipes, and the hot and cold HVAC fluid outlet pipes, permit the entire modular distribution box to be connected to and disconnected from the HVAC component and the HVAC system as a whole unit.

In the first aspect, the device can include a supply path valve and a return path valve, each of which can be housed by the modular distribution box. The supply path valve can be in fluid communication with the hot and cold HVAC fluid inlet pipes and the HVAC component supply pipe. The supply path valve can be configured to selectively provide HVAC fluid from either the hot HVAC fluid inlet pipe or the cold HVAC fluid inlet pipe to the HVAC component supply pipe. The return path valve can be in fluid communication with the HVAC component return pipe and the hot and cold HVAC fluid outlet pipes. The return path valve can be configured to selectively provide HVAC fluid from the HVAC component return pipe to either the hot HVAC fluid outlet pipe or the cold HVAC fluid outlet pipe.

In the first aspect, the device can include a controller housed by the modular distribution box. The controller can be configured to control the supply path valve and the return path valve.

In the first aspect, the device for enabling an HVAC component to be easily connected to, and disconnected from, an HVAC system may include one or more of the following features. The device can include a pump housed by the modular distribution box. In some such embodiments, the pump can be in fluid communication with the HVAC component supply pipe. In some such embodiments, the controller can be configured to control the pump. In some such embodiments, the controller can be configured to control the flow rate and/or displacement of the pump. The controller can be connected via a network to one or more components of the HVAC system. In some embodiments, the hot and cold HVAC fluid inlet pipes, the HVAC component supply and HVAC component return pipes, the hot and cold HVAC fluid outlet pipes, the supply path valve, and the return path valve are each constructed out of materials that do not erode in such a way as to contaminate potable water HVAC fluid.

As discussed herein, a second aspect of the present invention provides a method of enabling an HVAC component to be easily connected to, and disconnected from, an HVAC system. The method can include providing a first modular distribution box, such as those discussed in connection with the first aspect or others discussed herein. The method can include connecting the entire first modular distribution box, as a unit, to both the HVAC component and the HVAC system. Connecting the first modular distribution box to the HVAC component and the HVAC system can include connecting the first modular distribution box's hot HVAC fluid inlet pipe to a hot HVAC pipe, and connecting the first modular distribution box's cold HVAC fluid inlet pipe to a cold HVAC pipe. Connecting the first modular distribution box to the HVAC component and the HVAC system can include connecting the first modular distribution box's HVAC component supply pipe to an inlet pipe of the HVAC component, and connecting the first modular distribution box's HVAC component return pipe to an outlet pipe of the HVAC component. Connecting the first modular distribution box to the HVAC component and the HVAC system can include connecting the first modular distribution box's hot HVAC fluid outlet pipe to the hot HVAC pipe, and connecting the first modular distribution box's cold HVAC fluid outlet pipe to the cold HVAC pipe.

In the second aspect, the method can include disconnecting an entire second modular distribution box (e.g., those discussed in connection with the first aspect or others discussed herein), as a unit, from both the HVAC component and the HVAC system before connecting the first modular distribution box to both the HVAC component and the HVAC system. Disconnecting the second modular distribution box from both the HVAC component and the HVAC system can include disconnecting the second modular distribution box's hot HVAC fluid inlet pipe from the hot HVAC pipe, and disconnecting the second modular distribution box's cold HVAC fluid inlet pipe from the cold HVAC pipe. Disconnecting the second modular distribution box from both the HVAC component and the HVAC system can include disconnecting the second modular distribution box's HVAC component supply pipe from the inlet pipe of the HVAC component, and disconnecting the second modular distribution box's HVAC component return pipe from the outlet pipe of the HVAC component. Disconnecting the second modular distribution box from both the HVAC component and the HVAC system can include disconnecting the second modular distribution box's hot HVAC fluid outlet pipe from the hot HVAC pipe, and disconnecting the second modular distribution box's cold HVAC fluid outlet pipe from the cold HVAC pipe.

In the second aspect, the method can include one or more of the following steps/features. The method can include identifying a deficiency in the second modular distribution box before disconnecting the second modular distribution box from both the HVAC component and the HVAC system. The method can include transporting the second modular distribution box to a separate maintenance location remote from the HVAC component and the HVAC system after disconnecting the second modular distribution box from both the HVAC component and the HVAC system. The HVAC component can be a single fan coil that is uniquely associated with a single building zone. In some such embodiments, the building zone can be isolated from the HVAC system only for as long as it takes to disconnect the second modular distribution box and connect the first modular distribution box. The method can include constructing the first modular distribution box at a construction location remote to the HVAC component and the HVAC system. The method can include transporting the first modular distribution box to an HVAC location where the HVAC component and the HVAC system are located.

As discussed herein, a third aspect of the present invention provides a method of distributing temperature-controlled HVAC fluid to a component of an HVAC system. The method can include providing a modular distribution box, such as those discussed in connection with the first aspect or others discussed herein. The method can include connecting the entire modular distribution box, as a unit, to both the HVAC component and HVAC pipes (e.g., in a manner discussed in connection with the second aspect or in any other manner discussed herein). The method can include controlling the supply path valve and the return path valve via the modular distribution box's controller to channel HVAC fluid from the HVAC pipes through the HVAC component by way of the modular distribution box.

In the third aspect, the HVAC component can be a single fan coil that is uniquely associated with a single building zone. The method can include heating and/or cooling the building zone via the single fan coil. Controlling the supply path valve and the return path valve can include the modular distribution box's controller receiving input from a thermostat positioned in the building zone. The fan coil can include only one coil through which HVAC fluid passes. The fan coil can include only one fan. The method can include controlling the single fan coil by way of the modular distribution box so as to regulate air flow.

In the third aspect, the HVAC fluid can be potable water. Modular distribution box components and fan coil components can be constructed out of materials that do not erode in such a way as to contaminate the potable water. The method can include regularly (or periodically, or intermittently) circulating the potable water to prevent stagnation.

In the third aspect, the method can include one or more of the following steps/features. Controlling the supply path valve and the return path valve can include causing the supply path valve to selectively provide HVAC fluid from either the hot HVAC fluid inlet pipe or the cold HVAC fluid inlet pipe to the HVAC component supply pipe and causing the return path valve to selectively provide HVAC fluid from the HVAC component return pipe to either the hot HVAC fluid outlet pipe or the cold HVAC fluid outlet pipe. In embodiments in which the modular distribution box includes a pump, the method can include controlling the flow rate and/or displacement of the pump via the modular distribution box's controller. Controlling the supply path valve and the return path valve can include communicating with the modular distribution box's controller from a remote location via a network.

As discussed herein, a fourth aspect of the present invention provides a device for enabling an HVAC component to be easily connected to, and disconnected from, an HVAC system. The device can include a modular distribution box. The device can include HVAC system connection means for connecting the modular distribution box to hot and cold HVAC pipes. The device can include HVAC component connection means for connecting the modular distribution box to HVAC component inlet and outlet pipes. The device can include HVAC supply means for selectively providing HVAC fluid from either the hot HVAC pipe or the cold HVAC pipe to the HVAC component inlet pipe. The device can include HVAC return means for selectively providing HVAC fluid from the HVAC component outlet pipe to either the hot HVAC pipe or the cold HVAC pipe. The device can include control means for controlling the HVAC supply means and the HVAC return means. The HVAC system connection means and the HVAC component connection means can permit the entire modular distribution box to be connected to and disconnected from the HVAC component and the HVAC system as a whole unit.

In the third aspect, the device can include one or more of the following features. The device can include pump means for providing pressurized HVAC fluid to the HVAC component inlet pipe. In some such embodiments, the control means can control the pump means. The control means can include a network and a remote controller. The HVAC system connection means, the HVAC component connection means, the HVAC supply means, and the HVAC return means can each be constructed out of materials that do not erode in such a way as to contaminate potable water HVAC fluid.

In the foregoing detailed description, the invention has been described with reference to specific embodiments. However, it may be appreciated that various modifications and changes can be made without departing from the scope of the invention as set forth in the appended claims. Thus, some of the features of preferred embodiments described herein are not necessarily included in preferred embodiments of the invention which are intended for alternative uses.

1. A device for enabling an HVAC component to be easily connected to, and disconnected from, an HVAC system, the device comprising:
(a) a modular distribution box;
(b) hot and cold HVAC fluid inlet pipes, each coupled to the modular distribution box and each having a connector, the hot HVAC fluid inlet pipe's connector being configured to connect to a hot HVAC pipe, and the cold HVAC fluid inlet pipe's connector being configured to connect to a cold HVAC pipe;
(c) HVAC component supply and HVAC component return pipes, each coupled to the modular distribution box and each having a connector, the HVAC component supply pipe's connector being configured to connect to an inlet pipe of the HVAC component, and the HVAC component return pipe's connector being configured to connect to an outlet pipe of the HVAC component;
(d) hot and cold HVAC fluid outlet pipes, each coupled to the modular distribution box and each having a connector, the hot HVAC fluid outlet pipe's connector being configured to connect to the hot HVAC pipe, and the cold HVAC fluid outlet pipe's connector being configured to connect to the cold HVAC pipe;
(e) a supply path valve housed by the modular distribution box, the supply path valve being in fluid communication with the hot and cold HVAC fluid inlet pipes and the HVAC component supply pipe, the supply path valve being configured to selectively provide HVAC fluid from either the hot HVAC fluid inlet pipe or the cold HVAC fluid inlet pipe to the HVAC component supply pipe;
(f) a return path valve housed by the modular distribution box, the return path valve being in fluid communication with the HVAC component return pipe and the hot and cold HVAC fluid outlet pipes, the return path valve being configured to selectively provide HVAC fluid from the HVAC component return pipe to either the hot HVAC fluid outlet pipe or the cold HVAC fluid outlet pipe; and
(g) a controller housed by the modular distribution box, the controller being configured to control the supply path valve and the return path valve,
wherein the hot and cold HVAC fluid inlet pipes, the HVAC component supply and HVAC component return pipes, and the hot and cold HVAC fluid outlet pipes, permit the entire modular distribution box to be connected to and disconnected from the HVAC component and the HVAC system as a whole unit.

2. The device of claim 1, further comprising a pump housed by the modular distribution box, the pump being in fluid communication with the HVAC component supply pipe, wherein the controller is further configured to control the flow rate of the pump.

3. (canceled)

4. The device of claim 1, wherein the controller is connected via a network to one or more components of the HVAC system.

5. The device of claim 1, wherein the hot and cold HVAC fluid inlet pipes, the HVAC component supply and HVAC component return pipes, the hot and cold HVAC fluid outlet pipes, the supply path valve, and the return path valve are each constructed out of materials that do not erode in such a way as to contaminate potable water HVAC fluid.

6. A method of enabling an HVAC component to be easily connected to, and disconnected from, an HVAC system, the method comprising:
(a) providing a first modular distribution box that includes:
(i) hot and cold HVAC fluid inlet pipes,
(ii) HVAC component supply and HVAC component return pipes,
(iii) hot and cold HVAC fluid outlet pipes,
(iv) a supply path valve in fluid communication with the hot and cold HVAC fluid inlet pipes and the HVAC component supply pipe,
(v) a return path valve in fluid communication with the HVAC component return pipe and the hot and cold HVAC fluid outlet pipes, and
(vi) a controller configured to control the supply path valve and the return path valve; and
(b) connecting the entire first modular distribution box, as a unit, to both the HVAC component and the HVAC system by:
(i) connecting the first modular distribution box's hot HVAC fluid inlet pipe to a hot HVAC pipe, and connecting the first modular distribution box's cold HVAC fluid inlet pipe to a cold HVAC pipe,
(ii) connecting the first modular distribution box's HVAC component supply pipe to an inlet pipe of the HVAC component, and connecting the first modular distribution box's HVAC component return pipe to an outlet pipe of the HVAC component, and
(iii) connecting the first modular distribution box's hot HVAC fluid outlet pipe to the hot HVAC pipe, and connecting the first modular distribution box's cold HVAC fluid outlet pipe to the cold HVAC pipe.

7. The method of claim 6, further comprising (c) disconnecting an entire second modular distribution box, as a unit, from both the HVAC component and the HVAC system before connecting the first modular distribution box to both the HVAC component and the HVAC system,
wherein the second modular distribution box includes:
(i) hot and cold HVAC fluid inlet pipes,
(ii) HVAC component supply and HVAC component return pipes,
(iii) hot and cold HVAC fluid outlet pipes,
(iv) a supply path valve in fluid communication with the hot and cold HVAC fluid inlet pipes and the HVAC component supply pipe,
(v) a return path valve in fluid communication with the HVAC component return pipe and the hot and cold HVAC fluid outlet pipes, and
(vi) a controller configured to control the supply path valve and the return path valve, and
wherein disconnecting the second modular distribution box from both the HVAC component and the HVAC system includes:
(i) disconnecting the second modular distribution box's hot HVAC fluid inlet pipe from the hot HVAC pipe, and disconnecting the second modular distribution box's cold HVAC fluid inlet pipe from the cold HVAC pipe,
(ii) disconnecting the second modular distribution box's HVAC component supply pipe from the inlet pipe of the HVAC component, and disconnecting the second modular distribution box's HVAC component return pipe from the outlet pipe of the HVAC component, and
(iii) disconnecting the second modular distribution box's hot HVAC fluid outlet pipe from the hot HVAC pipe, and disconnecting the second modular distribution box's cold HVAC fluid outlet pipe from the cold HVAC pipe.

8. The method of claim 7, further comprising (d) identifying a deficiency in the second modular distribution box before disconnecting the second modular distribution box from both the HVAC component and the HVAC system.

9. The method of claim 8, further comprising (e) transporting the second modular distribution box to a separate maintenance location remote from the HVAC component and the HVAC system after disconnecting the second modular distribution box from both the HVAC component and the HVAC system.

10. The method of claim 7, wherein the HVAC component is a single fan coil that is uniquely associated with a single building zone and the building zone is isolated from the HVAC system only for as long as it takes to disconnect the second modular distribution box and connect the first modular distribution box.

11. The method of claim 6, further comprising (c) constructing the first modular distribution box at a construction location remote to the HVAC component and the HVAC system and (d) transporting the first modular distribution box to an HVAC location where the HVAC component and the HVAC system are located.

12. A method of distributing temperature-controlled HVAC fluid to a component of an HVAC system, the method comprising:
(a) providing a modular distribution box that includes:
(i) hot and cold HVAC fluid inlet pipes,
(ii) HVAC component supply and HVAC component return pipes,
(iii) hot and cold HVAC fluid outlet pipes,
(iv) a supply path valve in fluid communication with the hot and cold HVAC fluid inlet pipes and the HVAC component supply pipe,
(v) a return path valve in fluid communication with the HVAC component return pipe and the hot and cold HVAC fluid outlet pipes, and
(vi) a controller configured to control the supply path valve and the return path valve;
(b) connecting the entire modular distribution box, as a unit, to both the HVAC component and HVAC pipes by:
(i) connecting the modular distribution box's hot HVAC fluid inlet pipe to a hot HVAC pipe, and connecting the modular distribution box's cold HVAC fluid inlet pipe to a cold HVAC pipe,
(ii) connecting the modular distribution box's HVAC component supply pipe to an inlet pipe of the HVAC component, and connecting the modular distribution box's HVAC component return pipe to an outlet pipe of the HVAC component, and
(iii) connecting the modular distribution box's hot HVAC fluid outlet pipe to the hot HVAC pipe, and connecting the modular distribution box's cold HVAC fluid outlet pipe to the cold HVAC pipe; and
(c) controlling the supply path valve and the return path valve via the modular distribution box's controller to channel HVAC fluid from the HVAC pipes through the HVAC component by way of the modular distribution box.

13. The method of claim 12, wherein controlling the supply path valve and the return path valve includes causing the supply path valve to selectively provide HVAC fluid from either the hot HVAC fluid inlet pipe or the cold HVAC fluid inlet pipe to the HVAC component supply pipe and causing the return path valve to selectively provide HVAC fluid from the HVAC component return pipe to either the hot HVAC fluid outlet pipe or the cold HVAC fluid outlet pipe.

14. (canceled)

15. The method of claim 12, wherein controlling the supply path valve and the return path valve includes communicating with the modular distribution box's controller from a remote location via a network.

16. The method of claim 12, wherein the HVAC component is a single fan coil that is uniquely associated with a single building zone and the method further comprises (d) heating and/or cooling the building zone via the single fan coil.

17. The method of claim 16, wherein controlling the supply path valve and the return path valve includes the modular distribution box's controller receiving input from a thermostat positioned in the building zone.

18. The method of claim 16, wherein the fan coil includes only one coil through which HVAC fluid passes.

19. The method of claim 18, wherein the fan coil includes only one fan.

20. The method of claim 18, wherein the HVAC fluid is potable water.

21. (canceled)

22. The method of claim 20, further comprising (e) regularly circulating the potable water to prevent stagnation.

23. The method of claim 16, further comprising (e) controlling the single fan coil by way of the modular distribution box so as to regulate air flow.

24-27. (canceled)
